(19) United States
(12) Patent Application Publication
(10) Pub. No.: US 2026/0358827 A1
(43) Pub. Date: Nov. 12, 2026

(54) Picking System and Storage Unit Robot

(71) Applicant: Softbank Group Corp., Tokyo (JP)

(72) Inventor: Masayoshi Son, Minato-ku, Tokyo (JP)

(21) Appl. No.: 19/122,070

(22) PCT Filed: Oct. 5, 2023
(86) PCT No.: PCT/JP2023/036439

§ 371 Date: Apr. 17, 2025

(30) Foreign Application Priority Data
Oct. 20, 2022 (JP) 2022-168243
Nov. 10, 2022 (JP) 2022-180272
Nov. 16, 2022 (JP) 2022-183406
Nov. 22, 2022 (JP) 2022-186437
Dec. 2, 2022 (JP) 2022-193779
Dec. 5, 2022 (JP) 2022-194433
Jan. 30, 2023 (JP) 2023-012295

(51) Int. Cl. G05D 1/667; G05D 1/661; G05D 1/689; G05D 1/697; G05D 105/20; G05D 107/70; G05D 109/10; G05D 111/10

(52) U.S. Cl. CPC G05D 1/667; G05D 1/661; G05D 1/6895; G05D 1/697; G05D 2105/20; G05D 2107/70; G05D 2109/10; G05D 2111/10

(57) ABSTRACT

A picking system including: a pick-up arm that is attached to a first cart robot to pick up a basket; a passing arm that is attached to the first cart robot to send the basket to a second cart robot; a receiving arm that is attached to the second cart robot to receive the basket from the passing arm; an arm sensor group that is attached to a tip end portion of at least one of the pick-up arm, the passing arm, or the receiving arm; and an interpolation control unit that interpolates a blind spot of the vehicle body sensor group associated with the movement of the pick-up arm, the passing arm, and the receiving arm on the basis of information detected by the arm sensor group.

### TECHNICAL FIELD

The present disclosure relates to a picking system and a storage unit robot.

### BACKGROUND ART

In the related art, workers perform work at different speeds in picking in warehouses or manufacturing (for example, part assembly), packing work, or the like (hereinafter, referred to as picking work or the like) in factories.

In such a work environment, cart robots (hereinafter, may be simply referred to as carts) that are automatically controlled are introduced.

For example, a plurality of arms (a picking arm, a passing arm, a receiving arm, and the like) are attached to the cart robot, and cargo is transferred by controlling the postures of the arms.

For example, Japanese Patent Application Laid-Open (JP-A) No. 2019-093506 describes posture control for robots for automatically performing work in a production line of a factory.

### SUMMARY OF INVENTION

### Technical Problem

However, there is still room for improvement from the viewpoint of improving work efficiency in the picking work or the like using the cart robots.

The disclosure has been made in view of the above circumstances, and provides a picking system and a storage unit robot capable of improving work efficiency in picking work or the like using cart robots.

### Solution to Problem

A first aspect according to the technology of the disclosure is a picking system that processes work of picking up a basket that houses cargo by a first cart robot moving at a relatively low speed along a local lane and transferring the basket to a second cart robot moving at a relatively high speed along a fast lane under monitoring of a vehicle body sensor group attached to a vehicle body of each of the first cart robot and the second cart robot, including: a pick-up arm that is attached to the first cart robot to pick up the basket; a passing arm that is attached to the first cart robot to send the basket to the second cart robot; a receiving arm that is attached to the second cart robot to receive the basket from the passing arm; an arm sensor group that is attached to a tip end portion of at least one of the pick-up arm, the passing arm, or the receiving arm; and an interpolation control unit that interpolates a blind spot of the vehicle body sensor group associated with movement of the pick-up arm, the passing arm, and the receiving arm on a basis of information detected by the arm sensor group.

A second aspect according to the technology of the disclosure is the picking system according to the first aspect, in which the arm sensor group is attached to a tip end portion of any one of the pick-up arm, the passing arm, or the receiving arm in a multi-axis arm structure.

A third aspect according to the technology of the disclosure is the picking system according to the first or second aspect, in which the arm sensor group is attached inside a wrist-specification joint of any one of the pick-up arm, the passing arm, or the receiving arm in a multi-axis arm structure.

A fourth aspect according to the technology of the disclosure is the picking system according to any one of the first to third aspects, in which a step structure unit is provided between the local lane and the fast lane to transfer the basket discharged from the first cart robot to the second cart robot via a transfer path on which movement is possible using at least a height difference in a direction of gravity.

A fifth aspect according to the technology of the disclosure is the picking system according to the fourth aspect, in which the local lane is relatively high, the fast lane is relatively low, and the transfer path is an inclination unit connecting the local lane and the fast lane, and the basket discharged from the first cart robot slides down the inclination unit and moves to a catching position of the second cart robot.

A sixth aspect according to the technology of the disclosure is the picking system according to any one of the first to fifth aspects, in which a snake arm camera that is attached to the vehicle body and includes an arm unit capable of adjusting a connection angle of each of a plurality of link units connected via joint units by an adjustment mechanism unit, and an image-capturing unit attached to a tip end portion of the arm unit, and a blind spot determination unit that determines whether there is a blind spot region of the vehicle body sensor group generated during the series of work by the cart robot are provided, and the adjustment mechanism unit is controlled on a basis of a determination result in the blind spot determination unit to adjust a connection angle between the link units, and the blind spot region is interpolated by capturing an image thereof with the image-capturing unit.

A seventh aspect according to the technology of the disclosure is the picking system according to the sixth aspect, in which a pick-up arm that picks up the basket and a passing arm that sends the basket to the second cart robot are attached to the first cart robot, and a receiving arm that receives the basket from the passing arm is attached to the second cart robot, and the snake arm camera is attached to at least one of the first cart robot or the second cart robot separately from a working arm group constituting the pick-up arm, the passing arm, and the receiving arm.

An eighth aspect according to the technology of the disclosure is the picking system according to the sixth aspect, in which a pick-up arm that picks up the basket and a passing arm that sends the basket to the second cart robot are attached to the first cart robot, and a receiving arm that receives the basket from the passing arm is attached to the second cart robot, and a working arm group constituting the pick-up arm, the passing arm, and the receiving arm each functions as the snake arm camera.

A ninth aspect according to the technology of the disclosure is the picking system according to the eighth aspect, in which the image-capturing unit of the snake arm camera is attached inside a wrist-specification joint of the working arm group.

A tenth aspect according to the technology of the disclosure is the picking system according to any one of the first to ninth aspects, in which a charging work control unit is provided to control charging work for charging a battery serving as a power source of the first cart robot or the second cart robot, which is executed, in a case where the work is set as the series of normal work, as separate work from the series of normal work, and monitoring by the vehicle body sensor group and the arm sensor group is continued during the charging work.

An eleventh aspect according to the technology of the disclosure is the picking system according to the tenth aspect, in which the charging work is work including during traveling along the local lane, taking in a charging pack capable of charging the power source in place of the basket by the first cart robot, charging a battery of the first cart robot, or charging a battery of the second cart robot by transferring the charging pack to the second cart robot, and returning after charging, and the series of normal work is executed in parallel.

A twelfth aspect according to the technology of the disclosure is the picking system according to the tenth aspect, in which the charging work is work including drawing the first cart robot and the second cart robot that need to be charged to a charging station via charging lanes respectively connected to points with respect to the local lane and the fast lane, and sending to the local lane and the fast lane via the charging lanes after charging in the charging station, and the series of normal work is executed in parallel.

A thirteenth aspect according to the technology of the disclosure is a picking system that transports an object to be transported that houses cargo by using a cart robot, including: a normal work process control unit that processes normal work of picking up the object to be transported by an arm of a first cart robot moving at a relatively low speed along a local lane, and through transfer work for transferring to an arm of the second cart robot moving at a relatively high speed along a fast lane, transporting the object to be transported from a pick-up position to an unloading position; and a special work process control unit that processes special work in a case where a transport mode classified as special transport is selected for transport of the normal work.

A fourteenth aspect according to the technology of the disclosure is the picking system according to the thirteenth aspect, in which the transport mode classified as the special transport is a transport mode for an object to be transported that needs to be processed immediately or preferentially, and the special work process control unit moves a dedicated third cart robot for the special transport along a dedicated direct lane to pick up the object to be transported by an arm of the third cart robot and to directly transport the object to be transported from a pick-up position to a target position.

A fifteenth aspect according to the technology of the disclosure is the picking system according to the thirteenth or fourteenth aspect, in which the object to be transported is an irregularly-shaped object to be transported that has a shape that is difficult to process in the normal work, or a large number of objects to be transported exceeding a unit transport amount of the first cart robot and the second cart robot, and the special work process control unit executes transport control according to control of the normal work process control unit by using a dedicated fourth cart robot for special transport.

A sixteenth aspect according to the technology of the disclosure is the picking system according to any one of the thirteenth to fifteenth aspects, in which the normal work or the special work is executed under monitoring of a vehicle body sensor group attached to a vehicle body of the cart robot and an arm sensor group attached to a tip end portion of the arm.

A seventeenth aspect according to the technology of the disclosure is a picking system that processes work of picking up a basket that houses cargo by a first cart robot moving at a relatively low speed along a local lane and transferring the basket to a second cart robot moving at a relatively high speed along a fast lane under monitoring of a vehicle body sensor group attached to a vehicle body of each of the first cart robot and the second cart robot, including: an arm unit that is attached to the first cart robot to execute pick-up of the basket and transfer of the basket; an arm sensor group that is attached to a tip end portion of the arm unit; and a position control unit that controls a position of the second cart robot during transfer of the basket on a basis of information detected by the vehicle body sensor group and information detected by the arm sensor group.

An eighteenth aspect according to the technology of the disclosure is the picking system according to the seventeenth aspect, in which the position control unit further predicts a position of the first cart robot and movement of the arm unit on a basis of information detected by the arm sensor group to control the position of the second cart robot during transfer of the basket.

A nineteenth aspect according to the technology of the disclosure is a storage unit robot that is provided in a storage unit for a basket that houses cargo to pick up and transfer the basket to a cart robot moving along a lane under monitoring of a vehicle body sensor group, including: a pick-up arm that picks up the basket of the storage unit; an arm sensor group that is attached to a tip end portion of the pick-up arm; and a control unit that controls the pick-up arm to adjust an orientation of the basket during transfer of the basket from the pick-up arm to the cart robot on a basis of information detected by the vehicle body sensor group and information detected by the arm sensor group.

A twentieth aspect according to the technology of the disclosure is the storage unit robot according to the nineteenth aspect, in which the control unit controls the pick-up arm so that the cart robot can catch a handle of the basket during transfer of the basket.

A twenty-first aspect according to the technology of the disclosure is the storage unit robot according to the nineteenth or twentieth aspect, in which the control unit controls the pick-up arm to put out the basket in accordance with an interval between the cart robots moving on the lane.

### BRIEF DESCRIPTION OF DRAWINGS

FIG. 1 is a plan view of a floor of a warehouse with a picking system according to a first embodiment applied thereto.

FIG. 2 is a perspective view of a cart robot according to the first embodiment.

FIG. 3 is a perspective view showing a state when a basket is transferred from a local cart to a fast cart.

FIG. 4 is a flowchart showing a pick-up process control routine for the basket by the local cart according to the first embodiment.

FIG. 5 is a diagram schematically showing an example of a functional configuration of the cart robot.

FIG. 6 is a diagram schematically showing an example of computer hardware functioning as an information processing device of the cart robot in the first embodiment.

FIG. 7A is a perspective view of a five-finger hand robot according to a modification example of an arm according to the first embodiment.

FIG. 7B is a perspective view of the five-finger hand robot according to the modification example of the arm according to the first embodiment.

FIG. 7C is a perspective view of a three-finger simplified hand robot according to a modification example of the arm according to the first embodiment.

FIG. 7D is a perspective view of the three-finger simplified hand robot according to the modification example of the arm according to the first embodiment.

FIG. 8 is a perspective view of a cart robot according to a second embodiment.

FIG. 9 is a perspective view of a snake arm camera according to the second embodiment.

FIG. 10 is a functional block diagram of the connection angle adjustment control and the image-capturing control executed by a control unit of the snake arm camera according to the second embodiment.

FIG. 11 is a flowchart showing an operation control routine for the snake arm camera according to the second embodiment.

FIG. 12 is a plan view of a floor of a warehouse with a picking system according to a third embodiment applied thereto.

FIG. 13 is a cross-sectional view taken along line IX-IX of FIG. 12.

FIG. 14 is a perspective view of a cart robot according to a fourth embodiment, showing a state in which a basket as a charging pack is picked up from a charging zone of a storage unit.

FIG. 15 is a functional block diagram of a configuration of an operation device system that is controlled by the information processing device mounted on the cart robot and a battery management control unit that manages the charging state of a battery supplying power to the operation device system according to the fourth embodiment.

FIG. 16 shows a battery monitoring control routine that is activated at the start of driving according to the fourth embodiment.

FIG. 17 is a flowchart showing a charging operation control routine that is interrupted in a case where an instruction for change to a charging work program is issued according to the fourth embodiment.

FIG. 18 is a plan view of a floor of a warehouse with a picking system according to a fifth embodiment applied thereto.

FIG. 19 is a plan view of a floor of a warehouse with a picking system according to a sixth embodiment applied thereto.

FIG. 20 is a perspective view of a long object transport cart suitable for transporting a long object according to the sixth embodiment.

FIG. 21 is a perspective view of a spherical object transport cart suitable for transporting a spherical object according to the sixth embodiment.

FIG. 22 is a perspective view of a mass transport cart suitable for transporting a large number of baskets according to the sixth embodiment.

FIG. 23 is a flowchart showing a pick-up process control routine for transport of an irregularly-shaped object and transport work for a large number of baskets by the long transport cart, the spherical object transport cart, and the mass transport cart during special transport according to the sixth embodiment.

FIG. 24 is a perspective view of a fast cart according to a seventh embodiment.

FIG. 25 is a perspective view showing a state when a basket is transferred from a local cart to a fast cart in the seventh embodiment.

FIG. 26A is a diagram showing a positional relationship between the fast cart and the local cart during transfer of the basket in the seventh embodiment, and is a diagram showing a situation in a case where both carts approach each other.

FIG. 26B is a diagram showing a positional relationship between the fast cart and the local cart during transfer of the basket in the seventh embodiment, and is a diagram showing a situation in a case where transfer is performed between both carts.

FIG. 27A is a diagram showing another example of the positional relationship between the fast cart and the local cart during transfer of the basket in the seventh embodiment, and is a diagram showing a situation in a case where both carts approach each other.

FIG. 27B is a diagram showing another example of the positional relationship between the fast cart and the local cart during transfer of the basket in the seventh embodiment, and is a diagram showing a situation in a case where transfer is performed between both carts.

FIG. 28 is a plan view showing a state in which a storage unit robot grips a basket in a storage unit in an eighth embodiment.

FIG. 29 is a plan view showing a state when the basket is transferred from the storage unit robot to picking arms of a local cart approaching the storage unit in the eighth embodiment.

### DESCRIPTION OF EMBODIMENTS

Hereinafter, the disclosure will be described through embodiments of the disclosure, but the following embodiments do not limit the disclosure according to the claims. In addition, not all of the combinations of features described in the embodiments are essential to the solutions of the disclosure.

### First Embodiment

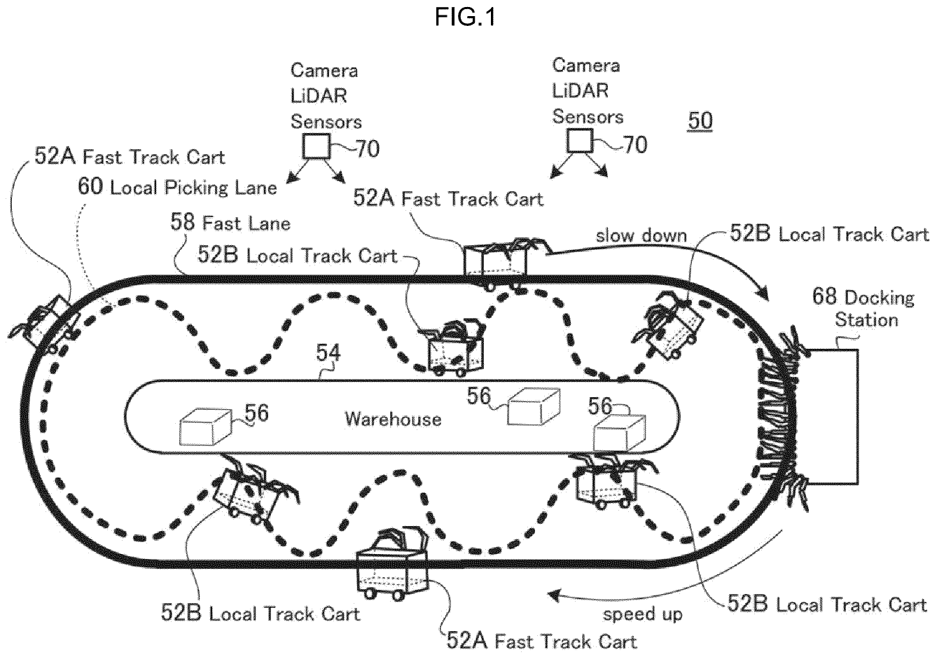

FIG. 1 is a plan view of a floor 50 of a warehouse with a picking system according to a first embodiment applied thereto.

The picking work is collecting (that is, picking up) necessary items. The picking staff (for example, cart robots 52 in the embodiment) plays an essential role in shipping items in a warehouse, so that they are positioned in all types of warehouses. Not only the cart robots but also humanoid robots may be used.

For example, their main job is to collect designated items based on a pre-specified list or order and to convey the collected items to an inspection person or a packing person, and since the larger the size of the warehouse, the larger the number of types and the number of stored items, a large number of picking staff move in the floor 50.

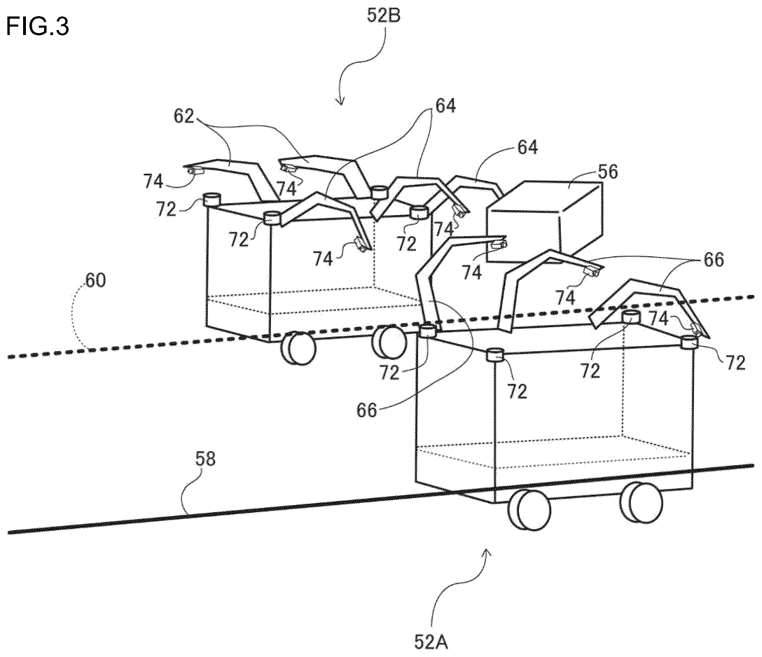

The floor 50 shown in FIG. 1 is provided with a storage unit (for example, a warehouse, a shelf, or the like) 54 in which a plurality of baskets 56 (see FIG. 3) are stored. The cart robots 52 are moved around the storage unit 54. The main role of the cart robots 52 is to hand over and receive the baskets 56. The cart robots 52 are classified into fast carts 52A as cart robots 52 moving along a fast lane 58 and local carts 52B as cart robots 52 moving along a local lane 60.

The local lane 60 is an inner lane in the floor 50. The local cart 52B temporarily decelerates to pick up the basket 56 from the storage unit 54 while traveling in a meandering manner to approach or move away from the storage unit 54.

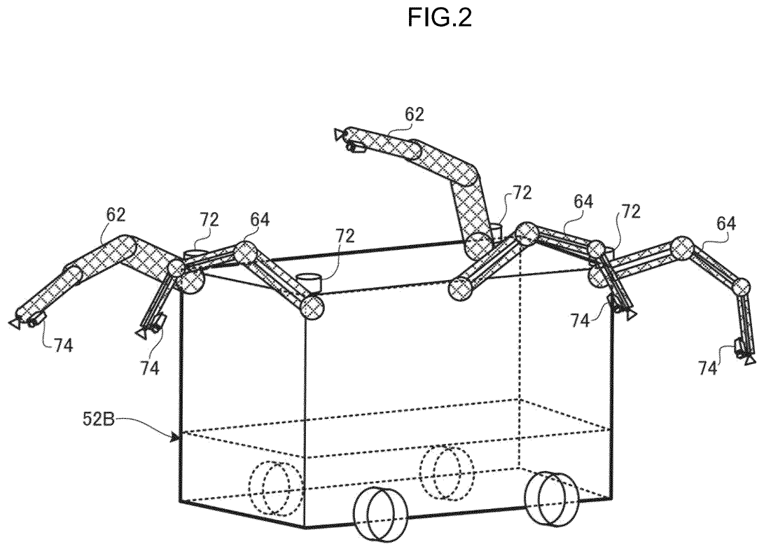

As shown in FIG. 2, the local cart 52B has a picking arm 62. In the local cart 52B, the picking arm 62 is provided inside (that is, the storage unit 54 side) the local lane 60. For example, two picking arms 62 are provided. The local cart 52B picks up the basket 56 containing cargo via the picking arms 62.

In addition, the local cart 52B has a passing arm 64. In the local cart 52B, the passing arm 64 is provided outside (that is, the fast lane 58 side) the local lane 60. For example, three passing arms 64 are provided. The local cart 52B passes the basket 56, via the passing arms 64, to the fast cart 52A moving on the fast lane 58.

The local cart 52B has a counter balance battery (not shown) for preventing falling incorporated therein.

The fast lane 58 is an outer lane in the floor 50. The fast cart 52A travels on the fast lane 58 at, for example, 20 Km/h, and receives the basket 56 from the local cart 52B moving on the local lane 60. Specifically, the fast cart 52A has a receiving arm 66. In the example shown in FIG. 3, the fast cart 52A has three receiving arms 66. The fast cart 52A receives the basket 56 from the local cart 52B via the receiving arm 66.

A series of work between the local cart 52B and the fast cart 52A is as follows, for example. After picking up the basket 56, the local cart 52B traveling on the local lane 60 temporarily accelerates and runs in parallel with the fast cart 52A traveling on the fast lane 58 outside the local lane 60. The speed during parallel running is, for example, 20 Km/h. Then, in a state in which the local cart 52B and the fast cart 52A are running in parallel, the basket 56 is transferred from the three passing arms 64 of the local cart 52B to the three receiving arms 66 of the fast cart 52A in the manner of relay baton passing.

On the floor 50, a docking station 68 is installed to correspond to the storage unit 54. That is, the docking station 68 is a place where the baskets 56 picked up from the storage unit 54 are accumulated.

In addition, the docking station 68 is a junction point between the fast lane 58 and the local lane 60.

The docking station 68 functions to receive the baskets 56 from the fast lane 58. The docking station 68 includes, for example, 20 arms.

In the docking station 68, the fast cart 52A temporarily decelerates, transfers the basket 56 to the arms of the docking station 68, and then re-accelerates. The speed of the fast cart 52A for the docking station 68 is, for example, 2 Km/h, and the time required for transfer is, for example, within 1 minute.

In the floor 50, in-warehouse sensor groups 70 including a camera and/or LiDAR are installed on a ceiling or a wall.

The in-warehouse sensor groups 70 measure an inter-vehicle distance between the fast cart 52A and the local cart 52B and/or a speed. The information collected by the in-warehouse sensor groups 70 is used as information for synchronizing the fast cart 52A and the local cart 52B with each other.

In addition, vehicle body sensor groups 72 including a camera and/or LiDAR are installed in a vehicle body (that is, a cart body) of each of the fast cart 52A and the local cart 52B. The inter-vehicle distances between the fast carts 52A and the local carts 52B are controlled to be equal on the basis of a result of dividing the length of each lane by the number of carts. Therefore, prediction for providing a necessary inter-vehicle distance (for example, 3 m or more) is possible.

In the picking system, since the fast cart and the local cart 52B in the floor 50 perform work at a synchronized tempo, it is possible to suppress an accident such as interference (for example, contact or collision). In addition, since the picking work is performed at a synchronized tempo, time waste can be minimized.

Here, the cart robot 52 according to the embodiment includes a plurality of arms as described above.

The local cart 52B includes, for example, two picking arms 62 and three passing arms 64. In addition, the fast cart 52A includes, for example, three receiving arms 66. Hereinafter, the arms may be collectively referred to as arms 62, 64, and 66.

The arms 62, 64, and 66 three-dimensionally move in work such as picking of the basket 56 or transfer of the basket 56 between the carts. Therefore, the arms 62, 64, and 66 cross a monitoring region of the vehicle body sensor groups 72 installed in the cart body.

A blind spot may occur in any of the vehicle body sensor groups 72 in association with the three-dimensional movement. In addition, the arms 62, 64, and 66 may move irregularly for work, and in particular, the closer to the tip end portions of the arms 62, 64, and 66, the greater the arm's movement trajectory amount. Furthermore, the blind spot of the vehicle body sensor group 72 changes in time-series.

Therefore, in the embodiment, arm sensor groups 74 including a small camera and/or LiDAR are attached to the tip end portions of the arms 62, 64, and 66 of the cart robots 52(for example, the fast cart 52A and the local cart 52B).

The arm sensor groups 74 at the tip end portions of the arms 62, 64, and 66 can reduce blind spots of the vehicle body sensor groups 72 of the cart body.

In addition, examples of the type of the arm sensor groups 74 at the tip end portions of the arms 62, 64, and 66 include a temperature sensor and a hardness sensor. By adding a temperature sensor, a hardness sensor, and/or the like to the arm sensor group 74, it is possible to set a grip strength and the like in the transfer (that is, gripping) of the basket 56. This can prevent deformation and/or damage to the basket 56.

As the in-warehouse sensor group 70, the vehicle body sensor group 72, and the arm sensor group 74, a highest-performance camera, a solid-state LiDAR, a multi-color laser coaxial displacement meter, and/or various other sensor groups can be adopted. Other examples thereof include a vibration meter, a thermo camera, a hardness meter, a radar, a LiDAR, and a high-pixel, telephoto, ultra-wide-angle, 360-degree, or high-performance camera. In addition, examples of the target that can be detected by the in-warehouse sensor group 70, the vehicle body sensor group 72, and the arm sensor group 74 include vision recognition, fine sound, ultrasonic wave, vibration, infrared ray, ultraviolet ray, electromagnetic wave, temperature, humidity, spot AI weather forecast, high-accuracy multi-channel GPS, low-altitude satellite information, and long-tail incident AI data.

In addition to the above information, the in-warehouse sensor group 70, the vehicle body sensor group 72, and the arm sensor group 74 detect an image, distance, vibration, heat, odor, color, sound, ultrasonic wave, ultraviolet ray, infrared ray, or the like. In addition, examples of the information detected by the in-warehouse sensor group 70, the vehicle body sensor group 72, and the arm sensor group 74 include the movement of the center of gravity of the cart robot 52, the detection of the material of the floor on which the cart robot 52 is installed, the detection of an outside air temperature, the detection of an outside air humidity, the detection of the angle of tilt of the floor from above, below, the side, and at an angle, and the detection of a moisture amount. The in-warehouse sensor group 70, the vehicle body sensor group 72, and the arm sensor group 74 perform the detection every nanosecond, for example.

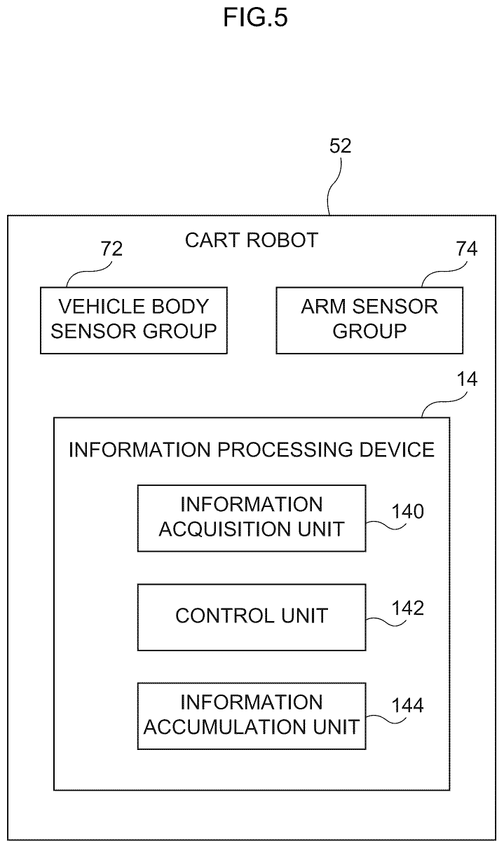

FIG. 5 is a control system block diagram of the vehicle body sensor group 72, the arm sensor group 74, and an information processing device 14 mounted on the cart robot 52.

The information processing device 14 includes an information acquisition unit 140, a control unit 142, and an information accumulation unit 144.

The information acquisition unit 140 acquires information on an object detected by the vehicle body sensor group 72 and the arm sensor group 74. In addition, the information acquisition unit 140 acquires not only the information on the object detected by the vehicle body sensor group 72 and the arm sensor group 74 of the cart robot 52 on which the above information acquisition unit 140 is mounted, but also the information on the object detected by the vehicle body sensor groups 72 and the arm sensor groups 74 of other cart robots 52 and the information on the object detected by the in-warehouse sensor group 70.

The control unit 142 controls the movement operation (for example, driving of wheels) of the entire cart robot 52, the operation of the arms 62, 64, and 66, and the like by using the information acquired by the information acquisition unit 140 and artificial intelligence (AI). In addition, the control unit 142 functions as an interpolation control unit in the disclosure.

For example, the control unit 142 executes the following processes.
(1) The arms 62, 64, and 66 and gripping units at their tip ends are driven to be able to grip an object.
(2) They are driven up and down to match the height of a work table of the storage unit 54.
(3)A balance is kept to prevent falling.
(4) Driving of wheels during movement is controlled.

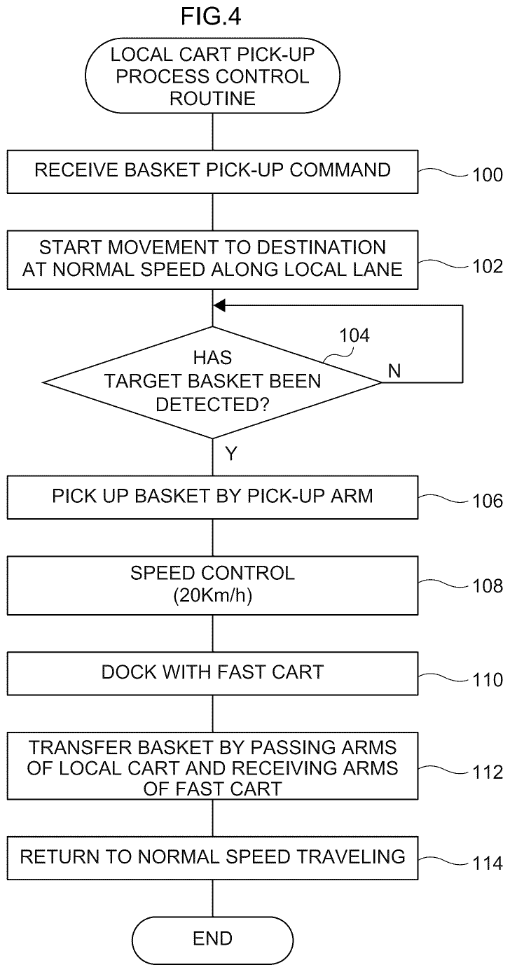

Hereinafter, actions of the embodiment will be described with reference to the flowchart of FIG. 4.

FIG. 4 is a flowchart showing a pick-up process control routine for the basket 56 by the local cart 52B.

In step 100, a command is received to pick up the basket 56. In the next step 102, the movement to a destination is started at a normal speed along the local lane 60.

In the next step 104, it is determined whether the target basket 56 has been detected. In a case where an affirmative determination is made, the process proceeds to step 106, where the basket 56 is picked up by the picking arms 62, and the process proceeds to step 108.

In step 108, the speed of the local cart 52B is controlled to be a set speed (for example, 20 Km/h). Then, the process proceeds to step 110, and the local cart 52B is docked with the fast cart 52A while meandering in the direction of the fast lane 58.

In the next step 112, the passing arms 64 of the local cart 52B and the receiving arms 66 of the fast cart 52A transfer the basket 56 from the local cart 52B to the fast cart 52A, and the process proceeds to step 114.

In step 114, the local cart 52B is returned to the normal speed traveling, and this routine ends to wait for the next command.

Meanwhile, since the arms 62, 64, and 66 three-dimensionally move on the basis of work such as the picking of the basket 56 and the transfer between the carts, the arms 62, 64, and 66 may cross a monitoring region of the vehicle body sensor groups 72 installed in the cart body, and a blind spot may occur in any of the vehicle body sensor groups 72.

However, in the embodiment, blind spots of the vehicle body sensor groups 72 of the cart body can be reduced by the arm sensor groups 74 at the tip end portions of the arms 62, 64, and 66.

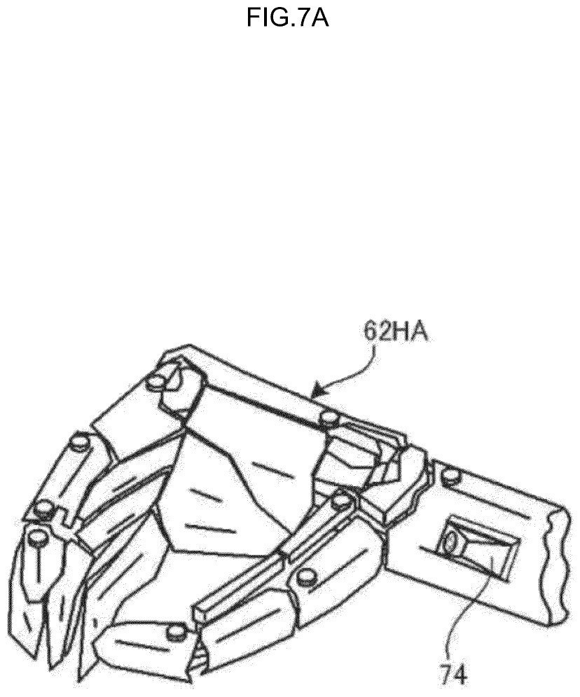

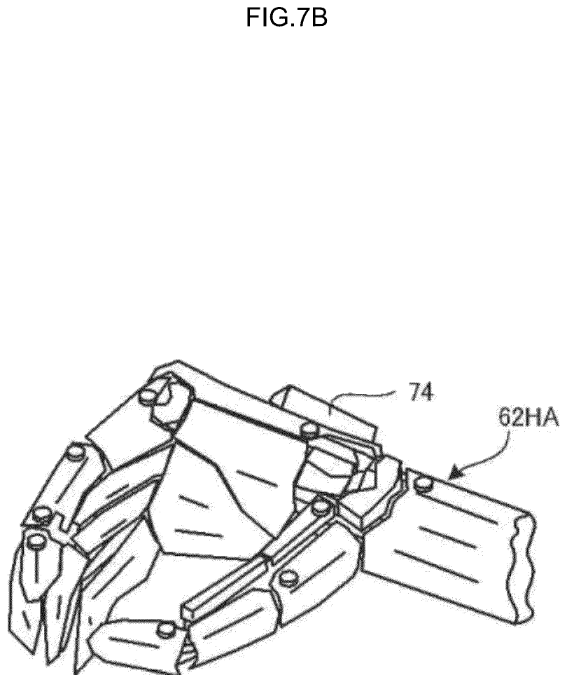

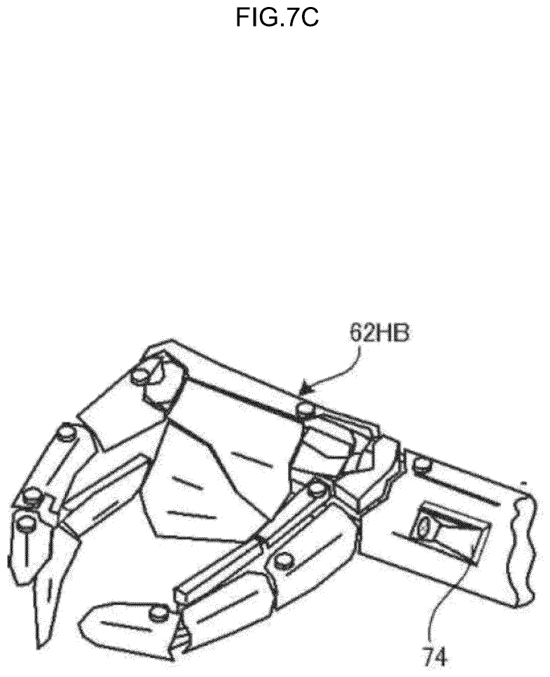

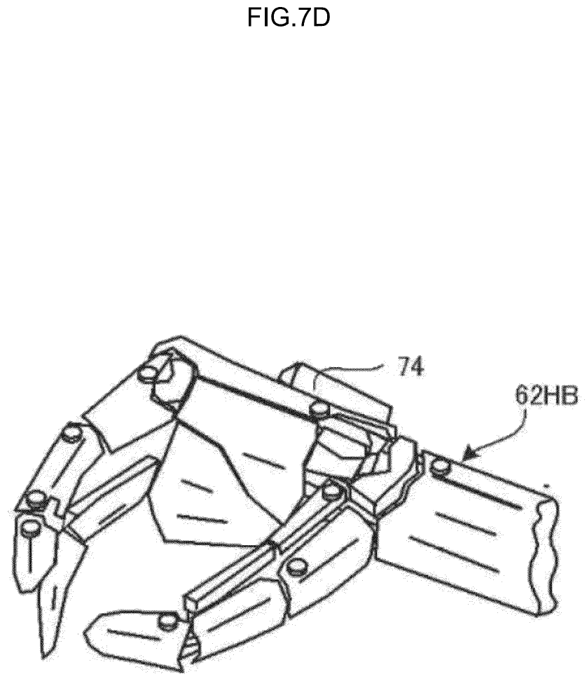

In a case where the arm sensor group 74 at the tip end portions of the arms 62, 64, and 66 includes a temperature sensor, a hardness sensor, and/or the like, a grip strength or the like can be adjusted in the transfer of the basket 56 (for example, gripping of the basket 56), and thus it is possible to prevent the basket 56 from being deformed or damaged. In addition, the tip end portions of the arms 62, 64, and 66 may be hand robots 62HA having five fingers like a human hand (see FIGS. 7A and 7B). In addition, the tip end portions of the arms 62, 64, and 66 may be simplified hand robots 62HB having three fingers (see FIGS. 7C and 7D). In that case, the arm sensor group 74 may be attached to a portion corresponding to a human wrist (see FIGS. 7A and 7C), or may be attached to a portion corresponding to the back of the hand (see FIGS. 7B and 7D). This is called an intelligent hand system.

According to the embodiment, the arm sensor group 74 is attached to the tip end portion of at least one of the arms 62, 64, or 66. On the basis of the information detected by the arm sensor group 74, a blind spot of the vehicle body sensor group 72 associated with the movement of the arms 62, 64, and 66 is interpolated.

Therefore, it is possible to reduce blind spots of the sensor groups monitoring the surroundings during the operation of the cart robot 52. By reducing the blind spots of the sensor groups, it is possible to avoid work defects (for example, interference including collision, contact, or the like between the fast cart 52A and the local cart 52B) caused by the occurrence of the blind spots. As a result, for example, the efficiency of the work by the cart robot 52 is improved.

### Second Embodiment

Hereinafter, a second embodiment of the disclosure will be described. In the second embodiment, the same components as those in the first embodiment are denoted by the same reference numerals, and description of their configurations is omitted.

A feature of the second embodiment is that, instead of the arm sensor groups 74 at the tip end portions of the arms 62, 64, and 66, an independent image-capturing device monitors a blind spot. In other words, in the first embodiment, the arm sensor group 74 is attached to each of the tip end portions of the arms 62, 64, and 66, so that the arms 62, 64, and 66 function not only as working arms but also as snake arm cameras to be described later.

Regarding this, in the second embodiment, a snake arm camera 76 having an independent configuration is provided for blind spot monitoring.

The carts including the snake arm camera 76 may be specific carts rather than all carts. In addition, in a case where the carts including the snake arm camera 76 are specific carts, the carts including the snake arm camera 76 are preferably positioned at regular intervals with respect to the total number of carts.

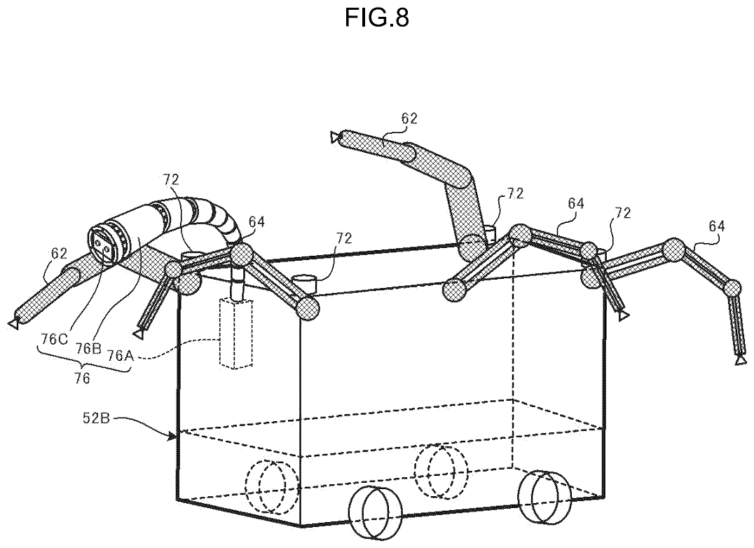

FIG. 8 is a perspective view of the cart robot according to the second embodiment.

In the second embodiment, separately from the arms 62, 64, and 66 of the cart robots 52(for example, the fast cart 52A and the local cart 52B), the snake arm camera 76 is attached to the cart body.

As shown in FIG. 8, the snake arm camera 76 has an arm unit 76B. The arm unit 76B is provided to protrude from the upper surface of an attachment base 76A. An image-capturing unit 76C is attached to a tip end of the arm unit 76B.

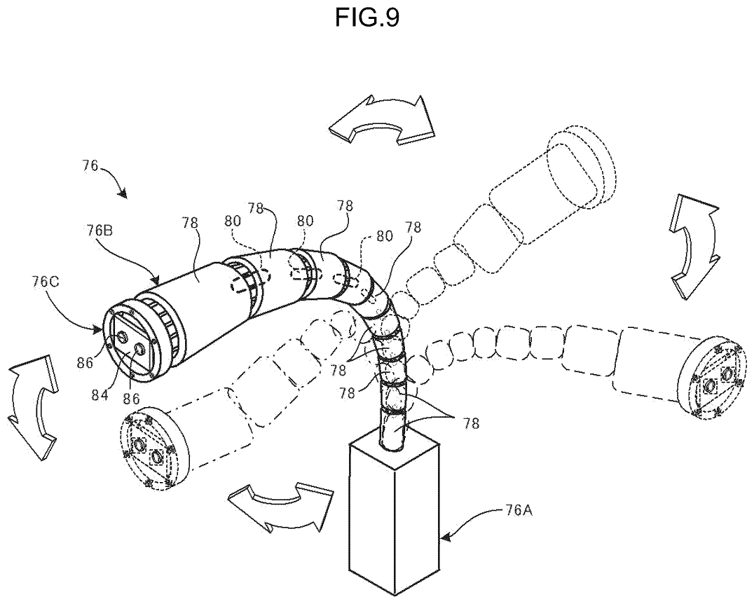

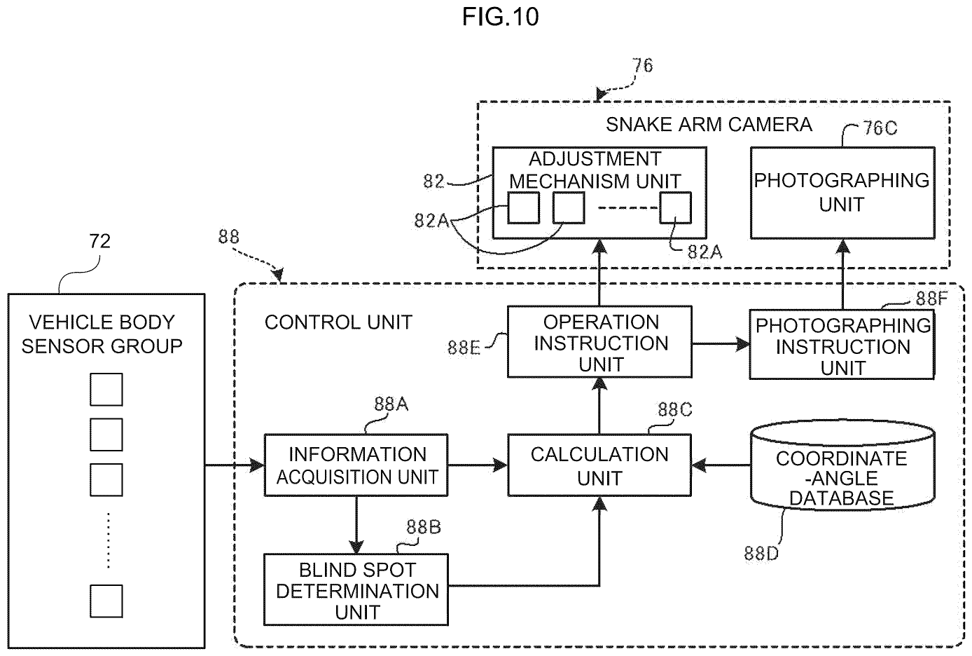

As shown in FIG. 9, a plurality of cylindrical link units 78 are arranged in series in the arm unit 76B. A joint unit 80 is attached between the link unit 78 and the link unit 78, and thus the joint unit 80 connects the adjacent link units 78 (a pair of the link units 78). The joint unit 80 has, for example, a ball joint mechanism. A pair of the link units 78 is rotatably connected with one point as an axis by the ball joint mechanism, and a relative angle between the pair of link units 78 can be adjusted by an adjustment mechanism unit 82 (see FIG. 10) provided inside the attachment base 76A. As a drive element of the adjustment mechanism unit 82, for example, a drive element such as a motor, a hydraulic cylinder, or a piezoelectric element can be applied. A plurality of drive elements may be combined.

The image-capturing unit 76C acquires an image for recognizing the distance to a subject. The image-capturing unit 76C has, for example, a planar base 84 and a pair of image-capturing elements 86 positioned in the base 84. The pair of image-capturing elements 86 is positioned so that optical axes thereof are substantially parallel to each other. Therefore, the distance to the subject can be recognized by performing an image process on the image captured by the image-capturing elements 86.

Each drive element of the adjustment mechanism unit 82 is controlled by, for example, a control unit 88 including a microcomputer (not shown). The control unit 88 controls the adjustment of a connection angle between the pair of link units 78 of the snake arm camera 76, and controls the image-capturing in the image-capturing unit 76C according to a predetermined program.

FIG. 10 is a functional block diagram of the connection angle adjustment control and the image-capturing control executed by the control unit 88.

The control unit 88 includes an information acquisition unit 88A, and the information acquisition unit 88A acquires detection information from each of the vehicle body sensor groups 72 attached to the cart body.

The information acquisition unit 88A is connected to a blind spot determination unit 88B. The blind spot determination unit 88B determines whether there is a blind spot around the cart robot 52 on the basis of the detection information acquired from the vehicle body sensor groups 72.

A determination result of the blind spot determination unit 88B is output to a calculation unit 88C.

In the calculation unit 88C, in a case where the determination result from the blind spot determination unit 88B is that “there is a blind spot,” a process of interpolating the blind spot by the snake arm camera 76 is executed.

For example, a coordinate-angle database 88D is connected to the calculation unit 88C.

The calculation unit 88C specifies the position (for example, coordinates) of the blind spot on the basis of the detection information received from the information acquisition unit 88A. In addition, the calculation unit 88C calculates the connection angle between the pair of link units 78 for capturing an image of a blind spot region by the image-capturing unit 76C on the basis of coordinate-angle data stored in the coordinate-angle database 88D.

A calculation result obtained by calculation of the calculation unit 88C is output to an operation instruction unit 88E. The operation instruction unit 88E is connected to the adjustment mechanism unit 82, and outputs a drive signal to each drive element 82A constituting the adjustment mechanism unit 82. Therefore, the drive element 82A adjusts the angle of each joint unit 80 so that the pair of link units 78 has a predetermined connection angle therebetween.

In addition, the operation instruction unit 88E is connected to an image-capturing instruction unit 88F. The operation instruction unit 88E outputs an activation signal to the image-capturing instruction unit 88F in synchronization with an operation instruction for the adjustment mechanism unit 82 (for example, at the end of the adjustment period).

The image-capturing instruction unit 88F executes image-capturing in the image-capturing unit 76C on the basis of the activation signal. Therefore, the snake arm camera 76 captures an image of the blind spot region of the vehicle body sensor groups 72 of the cart body.

Hereinafter, actions of the second embodiment will be described.

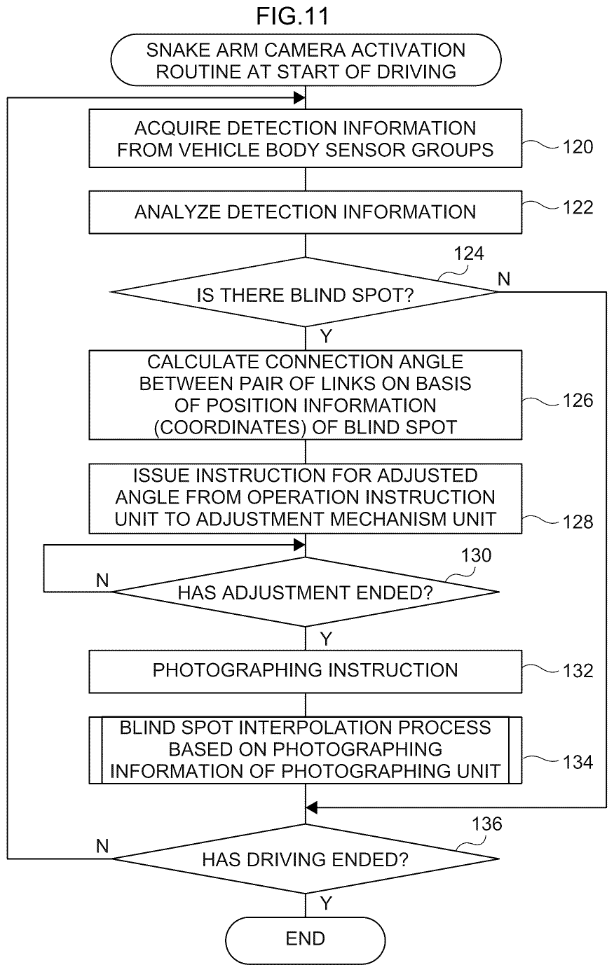

FIG. 11 is a flowchart showing an operation control routine for the snake arm camera.

In step 120, detection information is acquired from the vehicle body sensor groups 72. Then, the process proceeds to step 122, and the detection information is analyzed.

In the next step 124, as a result of the analysis in step 122, it is determined whether there is a blind spot around the cart robot 52 (in particular, near the arms 62, 64, and 66) in the monitoring by the vehicle body sensor groups 72.

In a case where an affirmative determination is made in step 124, it is determined that there is a blind spot, and the process proceeds to step 126. On the basis of position information (for example, coordinates) of the blind spot, a connection angle between the pair of link units 78 is calculated, and the process proceeds to step 128.

In step 128, an adjusted angle is instructed from the operation instruction unit 88E to the adjustment mechanism unit 82 on the basis of the connection angle calculated in step 126. According to this instruction, the adjustment mechanism unit 82 operates each drive element 82A.

In the next step 130, it is determined whether the adjustment has ended, and the adjustment is continued until an affirmative determination is made. As a result, the connection angle between the pair of link units 78 by the joint unit 80 is adjusted.

In a case where an affirmative determination is made in step 130, the process proceeds to step 132, and an image-capturing instruction is issued. On the basis of the image-capturing instruction, the image-capturing unit 76C captures an image of a blind spot region.

In the next step 134, blind spot interpolation control is executed on the basis of the image-capturing information of the image-capturing unit 76C, and the process proceeds to step 136. In a case where a negative determination is made in step 124, the process proceeds to step 136. In the interpolation control, for example, the image-capturing information obtained by capturing an image of the blind spot region may be sent to a control system (not shown) or the like that controls the vehicle body sensor groups 72. By sending the image-capturing information, the interpolation can be performed by normal image analysis by the control system.

In step 136, it is determined whether the driving has ended, and in a case where a negative determination is made, the process returns to step 120 and the above process is repeated. In addition, in a case where a negative determination is made in step 136, the routine ends.

Due to the above control, under the monitoring of the vehicle body sensor groups 72, for example, in the transfer work for the basket by the arms 62, 64, and 66, an image of the blind spot region generated due to the movement of the arms 62, 64, and 66 is captured via the snake arm camera 76. Here, since the free movement of the snake arm camera 76 is used, the snake arm camera 76 captures an image of the blind spot region without interfering with the arms 62, 64, and 66, and the like. Therefore, it is possible to increase the operation speeds of the arms 62, 64, and 66, leading to an improvement in work efficiency.

### Third Embodiment

Hereinafter, a third embodiment of the disclosure will be described. In the third embodiment, the same components as those in the first embodiment are denoted by the same reference numerals.

In the first embodiment, the arm sensor groups 74 are attached to the tip end portions of the arms 62, 64, and 66 to eliminate a blind spot of the sensor group monitoring the surroundings during automatic driving of the cart robot. By using the detection information of the arm sensor groups 74, it is possible to interpolate blind spot regions of other sensors, thereby avoiding work defects (for example, interference including collision, contact, or the like between the fast cart 52A and the local cart 52B) caused by the occurrence of the blind spots.

Regarding this, a feature of the third embodiment is specialized in avoiding interference between the fast cart 52A and the local cart 52B. More specifically, as a concept that aims to eliminate a blind spot occurring during the movement of the cart robot 52, a configuration that eliminates the presence of the blind spot itself, which is a cause of interference between the fast cart 52A and the local cart 52B, rather than interpolating the blind spot region by the arm sensor group 74, is provided.

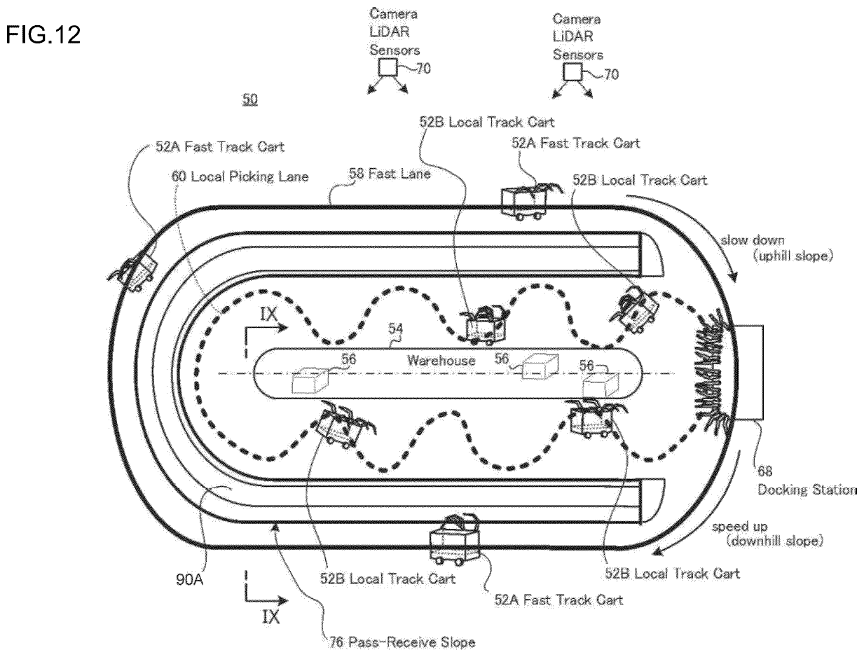

FIG. 12 is a plan view of a floor of a warehouse with a picking system according to a third embodiment applied thereto.

In the picking system, since the fast cart 52A and the local cart 52B in the floor 50 perform work at a synchronized tempo, they are controlled so that an accident such as interference (for example, contact or collision) does not occur.

However, in the transfer of the basket 56 from the local cart 52B to the fast cart 52A, the fast cart 52A and the local cart 52B are at their closest approach to each other.

In order to further reliably avoid interference between the arms 62, 64, and 66 at the time of closest approach, in the third embodiment, a step structure unit 90 (pass-receive slope) in a height direction is provided between the fast lane 58 and the local lane 60.

The step structure unit 90 is provided with an inclination unit 90A as a transfer path connecting the fast lane 58 and the local lane 60.

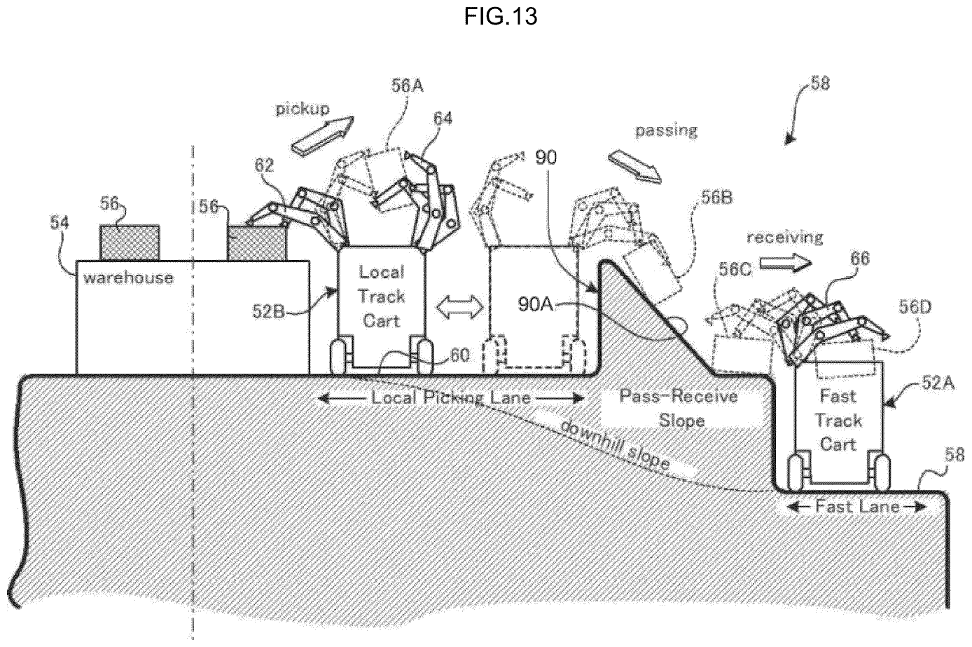

As shown in FIG. 13, due to the step structure unit 90, the fast lane 58 is relatively low, the local lane 60 is relatively high, and the inclination unit 90A is provided therebetween.

In a case where the local cart 52B approaches the storage unit 54 and receives the basket 56 placed in the storage unit 54 (in FIG. 13, basket 56A), the local cart 52B travels in a meandering manner to approach the step structure unit 90 and discharges the received basket 56A toward the inclination unit 90A (in FIG. 13, basket 56B). This work is referred to as “pass work.”

The discharged basket 56B slides down in the direction of the fast lane 58 along the inclination unit 90A (in FIG. 13, movement from the basket 56B to the basket 56C), and the fast cart 52A that is on standby receives the basket 56C and houses the received basket 56C (in FIG. 13, basket 56D). This work is referred to as “receive work.”

The transfer operation (pass work->receive work) of the basket 56 can be performed even while the fast cart 52A and the local cart 52B are traveling.

By transferring the basket 56 from the local cart 52B to the fast cart 52A via the step structure unit 90 having the above configuration (transition of the basket 56A->56B->56C->56D), even if there is a blind spot region in the detection information of the existing sensor groups (for example, the in-warehouse sensor groups 70 and the vehicle body sensor groups 72), it is possible to avoid a situation in which the local cart 52B and the fast cart 52A interfere with each other (for example, contact, collision, or the like), and thus a substantial blind spot can be eliminated.

According to the embodiment, in the picking system on the premise of the automatic driving of the fast cart 52A and the local cart 52B, by providing the step structure unit 90, it is possible to eliminate the region itself in which the carts interfere with each other during transfer. That is, a substantial blind spot region can be eliminated.

In addition, according to the embodiment, the local lane 60 is relatively high, the fast lane 58 is relatively low, and the transfer path is the inclination unit 90A connecting the local lane 60 and the fast lane 58. Then, the basket 56 discharged from the local cart 52B slides down the inclination unit 90A and moves to a catching position of the fast cart 52A.

By providing the region where the basket slides down the inclination unit 90A, it is possible to provide a constant interval between the local lane 60 and the fast lane 58, and it is possible to physically avoid interference between the fast cart 52A and the local cart 52B.

In the third embodiment, the basket 56 is allowed to slide down by gravity simply according to the inclination of the slope of the inclination unit 90A, but this is merely an example. For example, a belt conveyor or the like may be provided on the inclination unit 90A, and a transport speed of the belt conveyor may be controlled on the basis of position information when the fast cart 52A and the local cart 52B transfer the basket 56 while traveling, so that an error between the position for the pass work of the local cart 52B and the position for the receive work of the fast cart 52A may be adjusted.

In addition, in the third embodiment, with the inclination unit 90A of the step structure unit 90, the basket 56 is allowed to slide down along the inclination unit 90A, but an opening may be provided between the fast lane 58 and the local lane 60 to drop the basket 56 from the opening.

### Fourth Embodiment

Hereinafter, a fourth embodiment of the disclosure will be described. In the fourth embodiment, the same components as those in the first embodiment are denoted by the same reference numerals.

In the embodiment, the example has been described in which the arms 62, 64, and 66 are attached to the cart robot 52 (for example, the fast cart 52A and the local cart 52B), and the transfer of cargo is executed as a series of work by controlling the postures of the arms 62, 64, and 66. Here, separately from the series of work, in the movement based on irregular work, an unexpected blind spot may be present. Examples of the irregular work include charging work in which the cart robot 52 travels for charging.

Therefore, in the embodiment, it is realized to avoid an unexpected blind spot in the surroundings not only in the series of work but also in the traveling operation based on the charging work of the cart robot 52.

### Configuration of Storage Unit 54 for Charging Cart Robot 52

As described above, the local lane 60 is an inner lane in the floor 50, and the local cart 52B temporarily decelerates to pick up the basket 56 from the storage unit 54 while traveling in a meandering manner to approach or move away from the storage unit 54 (see FIG. 1).

The basket 56 containing cargo is placed in the storage unit 54, and a partial region (for example, a partial region at the left end of the storage unit 54 in FIG. 1) of the storage unit 54 is defined as a charging zone 54CZ. A basket 56L is placed as a charging pack different from the basket 56 containing cargo.

The basket 56L is, for example, a lithium ion battery, and is placed in the charging zone 54CZ to stand by in a state of being charged in advance.

Here, the basket 56L is handled the same as the basket 56 containing cargo, and can be picked up by the local cart 52B.

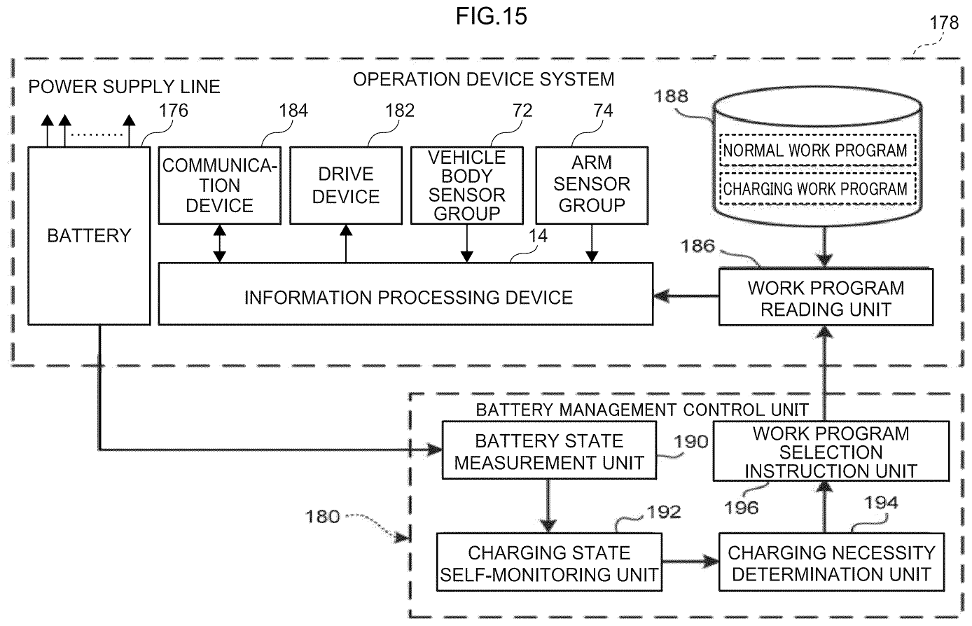

Although details will be described later, the picked-up basket 56L has a role of charging a battery 176 (see FIG. 15) mounted on the local cart 52B performing the above pick-up operation or the fast cart 52A performing the transfer via the local cart 52B. In the embodiment, the local cart 52B has a battery 176 (see FIG. 15) also serving as a counter balance for preventing falling incorporated therein.

In addition, in the embodiment, the docking station 68 may be provided with a charging zone (not shown) having the same function as the charging zone CZ provided in the storage unit 54, and the basket 56L dedicated to the fast cart 52A may be placed therein.

### Control System for Charging Battery of Cart Robot 52

FIG. 15 is a functional block diagram of a configuration of an operation device system 178 that is controlled by the information processing device 14 mounted on the cart robot 52 and a battery management control unit 180 that manages the charging state of the battery 176 supplying power to the operation device system 178.

The operation device system 178 includes the battery 176. The battery 176 supplies power to a drive device 182 and a communication device 184, in addition to the information processing device 14 and the vehicle body sensor groups 72 and the arm sensor groups 74 connected to the information processing device 14.

A work program reading unit 186 is connected to the information processing device 14. A recording medium 188 storing a work program is connected to the work program reading unit 186. The work program reading unit 186 reads, from the recording medium 188, a normal work program for executing a series of work or a charging work program for executing charging work that is irregular work on the basis of an instruction from the battery management control unit 180. The charging work program preferably includes a normal work program.

The read work program is sent to the information processing device 14, and each unit in the operation device system 178 is controlled on the basis of the read work program.

The charging work exemplified in the embodiment is managed by the battery management control unit 180.

As shown in FIG. 15, the battery management control unit 180 includes a battery state measurement unit 190. The battery state measurement unit 190 is connected to the battery 176 of the operation device system 178, measures a state (for example, a voltage or the like) of the battery 176, and outputs a measurement result to a charging state self-monitoring unit 192.

The charging state self-monitoring unit 192 checks the state of the battery 176 (for example, whether necessary and sufficient power can be supplied to the operation device system 178) and outputs a check result to a charging necessity determination unit 194.

The charging necessity determination unit 194 comprehensively determines the necessity of charging on the basis of the check result, and outputs a result of the determination to a work program selection instruction unit 196.

Upon receiving the determination result that charging is necessary, the work program selection instruction unit 196 instructs the work program reading unit 186 of the operation device system 178 to read the charging work program.

Therefore, the information processing device 14 changes the operation from the normal work program to the charging work program, and controls each unit in the operation device system 178. In a case where the normal work program is included in the charging work program, the normal work can be processed in parallel during the charging work.

In the charging work program, control is executed to cause the local cart 52B to pick up the basket 56L, which is a charging pack, from the charging zone 54CZ (see FIG. 1) of the storage unit 54, and charge the battery 176 of its own or transfer the basket 56L to the designated fast cart 52A.

In addition, upon receiving the determination result that charging is not necessary (for example, charging completed), the work program selection instruction unit 196 instructs the work program reading unit 186 of the operation device system 178 to read the normal work program.

### Control for Charging Battery of Cart Robot 52

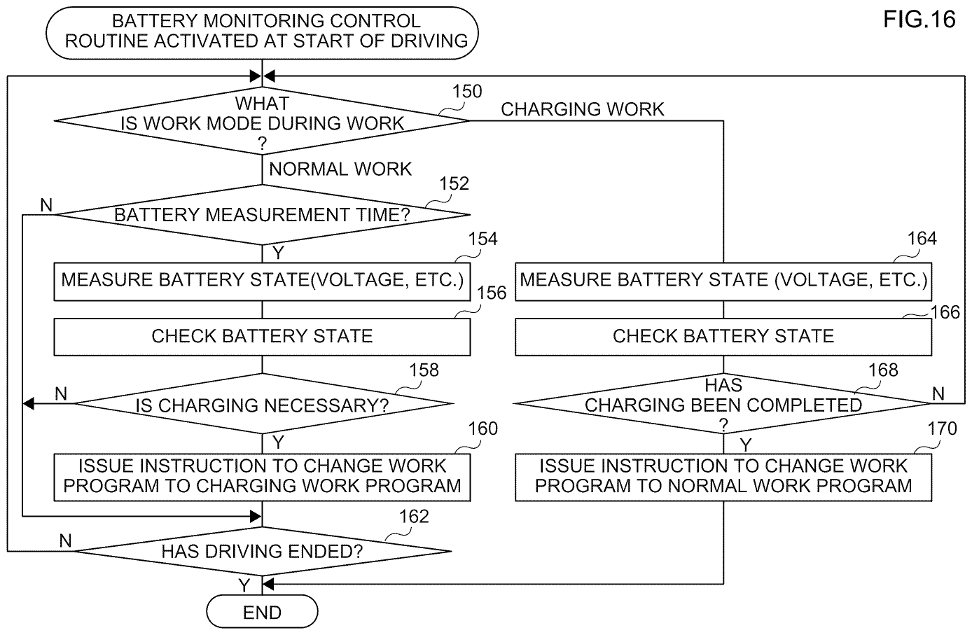

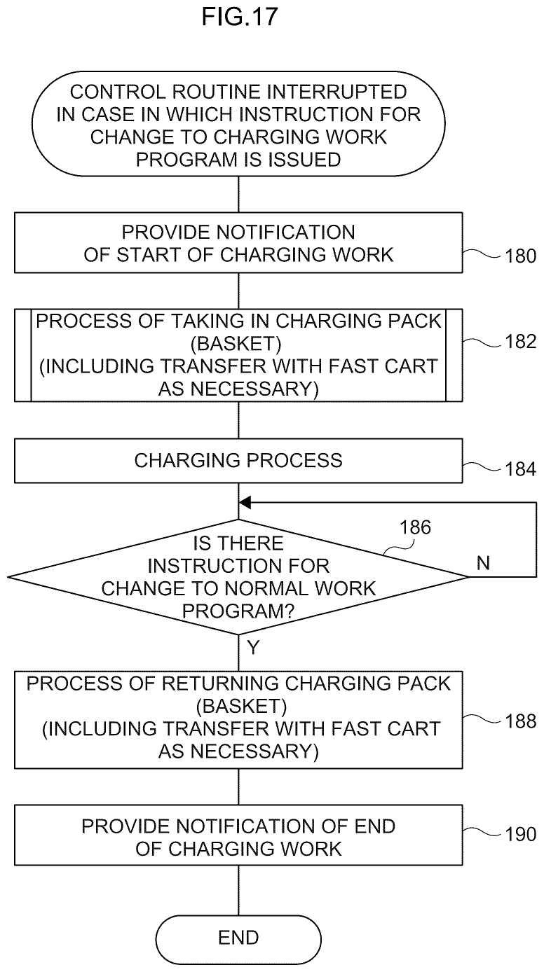

FIGS. 16 and 17 are flowcharts showing a flow of control for charging the cart robot 52.

FIG. 16 shows a battery monitoring control routine that is activated at the start of driving. The battery monitoring control in FIG. 16 is executed in parallel with (by Interrupting as appropriate) the local cart pick-up process control shown in FIG. 4.

In step 150, the work mode of each cart robot 52 during work is determined. In a case where the work mode is determined to be a normal work mode in step 150, it is determined that the cart robot 52 is not charged, and the process proceeds to step 152 to determine whether it is the measurement time of the battery 176.

In a case where an affirmative determination is made in step 152, the process proceeds to step 154, where the state (voltage or the like) of the battery 176 is measured, and the process proceeds to step 156.

In step 156, the state of the battery 176 is checked on the basis of the measured information, and the process proceeds to step 158.

In step 158, it is determined whether charging is currently necessary for the battery 176. In a case where an affirmative determination is made in step 158, it is determined that the battery 176 needs to be charged, the process proceeds to step 160, where an instruction is issued to change the work program to the charging work program, and the process proceeds to step 162. Even during activation of the charging work program, the normal work can be processed in parallel, although the amount of the cargo mounted is reduced.

In a case where a negative determination is made in step 152 or step 158, the process proceeds to step 162.

In step 162, it is determined whether the driving has ended. In a case where a negative determination is made, the process returns to step 150, and in a case where an affirmative determination is made in step 162, the routine ends.

Meanwhile, in the determination of the work mode in step 150, in a case where it is determined that the charging work is performed, it is determined that a series of normal work is performed while the basket 56L that is a charging pack is mounted, the process proceeds to step 164, where the state (voltage or the like) of the battery 176 is measured, and the process proceeds to step 166.

In step 166, the state of the battery 176 is checked on the basis of the measured information, and the process proceeds to step 168.

In step 168, it is determined whether charging of the battery 176 has been currently completed. In a case where an affirmative determination is made in step 168, it is determined that charging to the battery 176 has been completed, the process proceeds to step 170, where an instruction is issued to change the work program to the normal work program, and the routine ends. With the instruction, work of returning the basket 56L to the charging zone 54CZ of the storage unit 54 is executed to return to a series of normal work.

In addition, in a case where a negative determination is made in step 168, the process returns to step 150.

FIG. 17 is a flowchart showing a charging operation control routine that is interrupted in a case where an instruction for change to the charging work program is issued.

In step 180, the start of charging work is notified. Then, the process proceeds to step 182, and a process of taking in the charging pack (basket 56L) is executed. The take-in process is a step of picking up the basket 56L from the charging zone 54CZ of the storage unit 54 by the local cart 52B to connect the basket 56L to the battery 176. In a case where the charging target is the fast cart 52A, a transfer step from the local cart 52B to the fast cart 52A is included.

In the next step 184, a charging process is executed, and the process proceeds to step 186

In step 186, it is determined whether there is an instruction for change to the normal work program, and the process stands by until an affirmative determination is made (that is, charging is continued).

In a case where an affirmative determination is made in step 186, the process proceeds to step 188, and a process of returning the charging pack (for example, basket 56L) is executed. The return process is a step of removing the charging pack (for example, basket 56L) connected to the battery 176 and returning the charging pack to the charging zone 54CZ of the storage unit 54. In a case where the charging target is the fast cart 52A, a transfer step from the fast cart 52A to the local cart 52B is included.

In the next step 190, the end of the charging work is notified, and the routine ends.

According to the embodiment, in a series of normal work and charging work that is irregular work, the fast cart 52A and the local cart 52B are executed with almost the same operation (that is, transfer of the basket 56 and transfer of the basket 56L), and thus the monitoring by the in-warehouse sensor groups 70, the vehicle body sensor groups 72, and the arm sensor groups 74 and the control of blind spot avoidance established in the series of normal work can also be used during the charging work.

That is, according to the embodiment, it is possible to eliminate a blind spot of the vehicle body sensor group 72 monitoring the surroundings during a series of normal work by automatic driving of the cart robot 52. In addition, in the monitoring of a series of normal work, the charging work that is processed in parallel with the series of normal work can also be continuously monitored.

In addition, according to the embodiment, in a series of normal work and charging work, the fast cart 52A and the local cart 52B do not deviate from the fast lane 58 and the local lane 60, respectively, and thus, the monitoring region caused due to the charging work does not expand.

### Fifth Embodiment

Hereinafter, a fifth embodiment of the disclosure will be described. In the fourth embodiment, the same components as those in the fifth embodiment are denoted by the same reference numerals, and description of their configurations is omitted.

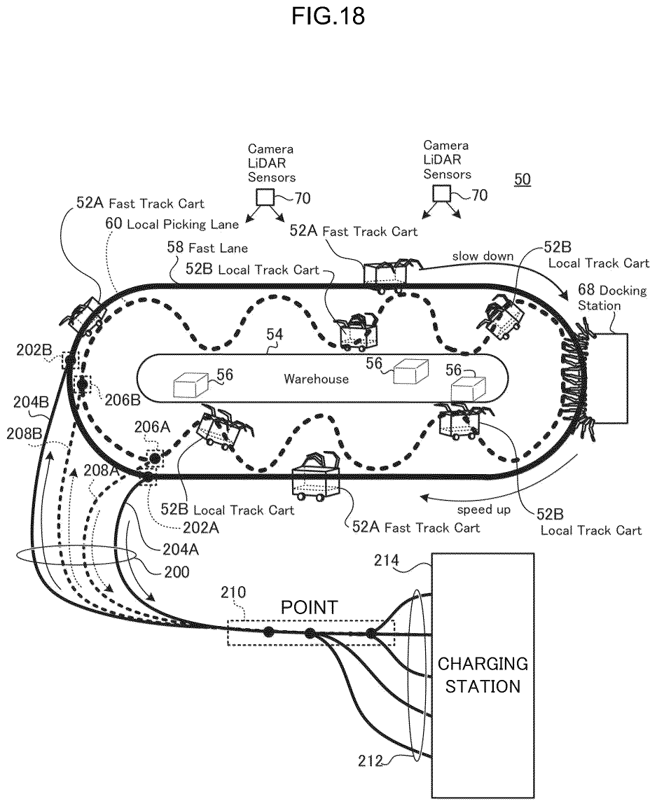

As shown in FIG. 18, a feature of the fifth embodiment is that a charging lane 200 is provided in addition to the fast lane 58 on which the fast cart 52A travels and the local lane 60 on which the local cart 52B travels.

As shown in FIG. 18, the charging lane 200 includes an incoming lane 204A and an outgoing lane 204B, and an incoming lane 208A and an outgoing lane 208B. The incoming lane 204A and the outgoing lane 204B are connected to the fast lane 58 via points 202A and 202B. In addition, the incoming lane 208A and the outgoing lane 208B are connected to the local lane 60 via points 206A and 206B.

A point group 210 is provided at a terminal of the charging lane 200, and can switch the connection state of each charging lane 200.

A plurality of branch lanes 212 are provided from the point group 210, and a charging station 214 is installed at a terminal of the branch lane 212.

In the charging station 214, in a case where the fast cart 52A and the local cart 52B respectively traveling on the fast lane 58 and the local lane 60 move via the charging lane 200 and the branch lane 212, charging to the batteries 176 mounted thereon is executed.

Hereinafter, actions of the fifth embodiment will be described.

In a case where any one of the fast carts 52A needs to be charged, the point 202A is switched so that the fast cart 52A is drawn from the fast lane 58 to the incoming lane 204A.

The fast cart 52A drawn to the incoming lane 204A is guided to the designated branch lane 212 with the switching operation of the point group 210, and reaches the charging station 214.

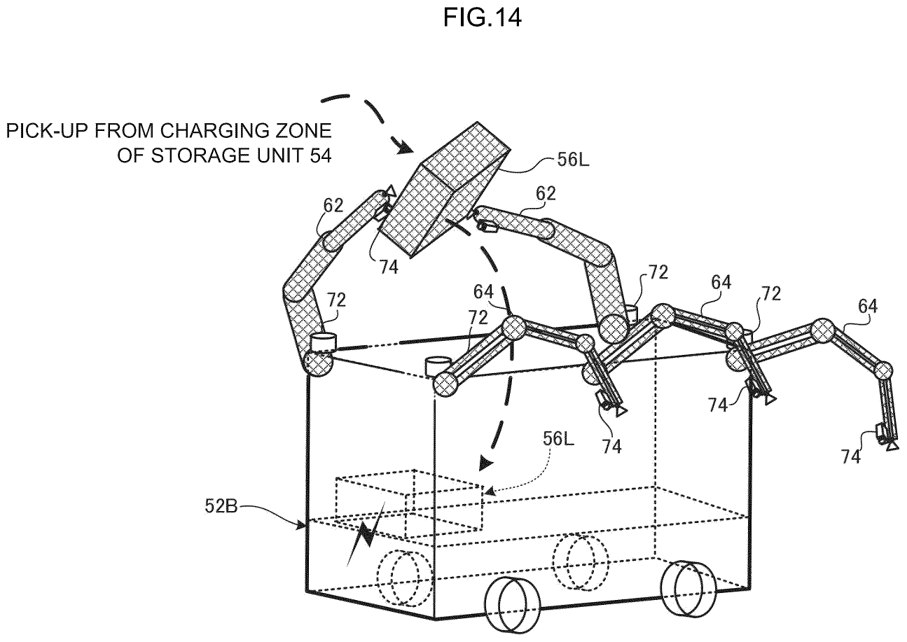

In the charging station 214, the battery 176 (see FIG. 14) is charged. In a case where the charging ends, the fast cart 52A is guided from the branch lane 212 to the outgoing lane 204B with the switching operation of the point group 210, and returns to the fast lane 58.

In addition, in a case where any one of the local carts 52B needs to be charged, the point 206A is switched so that the local cart 52B is drawn from the local lane 60 to the incoming lane 208A.

The local cart 52B drawn to the incoming lane 208A is guided to the designated branch lane 212 with the switching operation of the point group 210, and reaches the charging station 214 with the switching of the point 202B.

In the charging station 214, the battery 176 (see FIG. 14) is charged. In a case where the charging ends, the local cart 52B is guided from the branch lane 212 to the outgoing lane 208B with the switching operation of the point group 210, and returns to the local lane 60 with the switching of the point 206B.

The plurality of fast carts 52A and the plurality of local carts 52B are appropriately monitored for their charging states, and are guided to the charging station 214 and charged if charging is necessary, so that they are not disabled from traveling due to a battery shortage during a series of work.

In addition, in the guiding to the charging station 214, the cart travels while monitoring the surroundings by the vehicle body sensor groups 72 and the arm sensor groups 74 in a state in which there is no blind spot, and thus no defect occurs such as interference of the plurality of cart robots 52 with each other in the charging lane, the point group 210, the branch lane 212, and the like.

According to the embodiment, the fast cart 52A and the local cart 52B may deviate from the fast lane 58 and the local lane 60, respectively, but by providing the arm sensor group 74 even in the monitoring region where the cart deviates, no blind spot occurs.

In the fourth embodiment and the fifth embodiment, baskets 56L housing charging packs of a plurality of types of charge capacities may be prepared and selected to be picked up according to the capacity required for charging. In addition, charging may be performed in a non-contact manner. Furthermore, if a non-contact charging unit is embedded along the fast lane 58 and the local lane 60, charging work can be performed without any limitation on normal work.

### Sixth Embodiment

Hereinafter, a sixth embodiment of the disclosure will be described. In the sixth embodiment, the same components as those in the first embodiment are denoted by the same reference numerals, and description of their configurations is omitted.

Objects to be transported that are transported by the cart robots 52 have various shapes, and for example, in a case where the object is housed in a regular basket 56 to obtain a constant outer shape, the picking work efficiency can be improved. However, in a case where there is irregularly-shaped cargo that cannot be housed in the basket 56, the normal transport work may be hindered. Examples of the irregularly-shaped cargo include a long object that cannot be physically housed in the basket 56, a spherical object that is not stable during transport, and/or a large number of objects to be transported exceeding the housing volume of the cart robot 52.

In addition, the sensors installed in the cart robot 52 are basically attached to the vehicle body, and the sensors monitor obstacles or the like in the movement of the cart robot 52. However, for example, a blind spot may occur in the sensors along with the movement of the plurality of arms 62, 64, and 66.

Since the arms 62, 64, and 66 irregularly move on the basis of a command program (in particular, the closer to the tip end portions, the greater the arm's movement trajectory amount), the blind spot changes in time series. In particular, the sensor groups attached to the vehicle body of the related art cannot sufficiently monitor an irregularly-shaped object in some cases. In addition, in a case where the arms 62, 64, and 66 pick cargo from the basket 56, the inside of the basket 56 is a blind spot from the sensors of the cart robot 52.

Therefore, in the embodiment, in the picking work of the cart robot 52, even if the transport mode is changed according to the shape and/or amount of an object to be transported, it is possible to quickly handle the change without hindering the normal work.

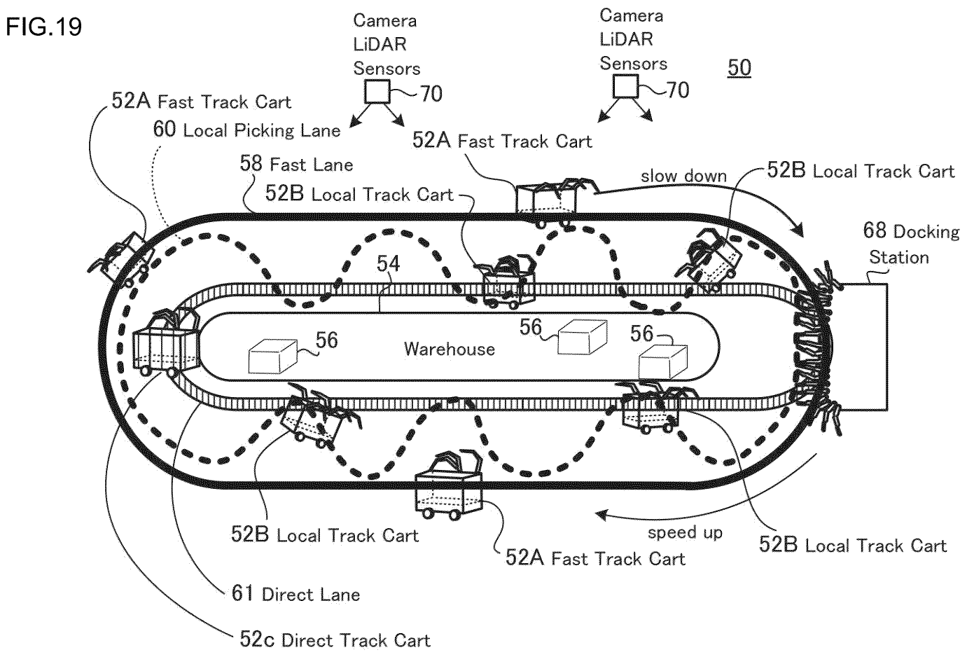

The cart robots 52 mainly play a role of transferring the baskets 56, and in the embodiment, the cart robots 52 are classified as follows according to their moving path.
(Moving Path 1) Fast carts 52A (see FIG. 19) as cart robots 52 moving along the fast lane 58
(Moving Path 2) Local carts 52B (see FIG. 19) as cart robots 52 moving along the local lane 60
(Moving Path 3) Direct carts 52C (see FIG. 19) as cart robots moving along a direct lane 61

As described in the first embodiment, the fast cart 52A on the moving path 1 and the local cart 52B on the moving path 2 work in a pair (cooperative work). Meanwhile, the direct cart 52C on the moving path 3 individually executes work (individual work).

### Details of Individual Work

As shown in FIG. 19, the direct lane 61 is an innermost lane provided along the storage unit 54 in the floor 50. While rotating around the storage unit 54, the direct cart 52C temporarily decelerates to pick up the basket 56 from the storage unit 54.

Similarly to the local cart 52B shown in FIG. 2, the direct cart 52C picks up the basket 56 containing cargo with the picking arms 62, and then directly transports the basket 56 to a target position (for example, docking station 68).

In the docking station 68, similarly to the fast cart 52A shown in FIG. 3, the direct cart 52C temporarily decelerates, transfers the basket 56 to the arms of the docking station 68, and then re-accelerates. The speed of the direct cart 52C for the docking station 68 is, for example, 2 Km/h, and the time required for transfer is, for example, within 1 minute.

Since the direct cart 52C is for so-called irregular work (express transport, priority transport, or the like), the direct cart 52C may stand by at a standby position (not shown) adjacent to the docking station 68 in a case where there is no next instruction of irregular work.

### Type of Cart Robot 52

The cart robot 52 described above is a cart robot 52 having a so-called standard structure capable of generally transporting the basket 56.

In other words, the baskets 56 have substantially the same outer shape and house cargo of various shapes, and thus the cart robot 52 can be loaded with many baskets 56 in an organized state.

Regarding this, irregularly-shaped cargo or the like that cannot be housed in the basket 56 may hinder the picking work. For example, it may result in situations where it takes a long time to take out the cargo from the storage unit 54, where it is difficult to transfer the cargo, and/or it is difficult to house the cargo in the cart robot 52. In addition, in a case where it is necessary to transport the baskets 56 with a capacity equal to or more than the load capacity of the cart robot 52 (for example, a large number of baskets 56) at a time, the cart robot 52 having a standard structure cannot handle the above case.

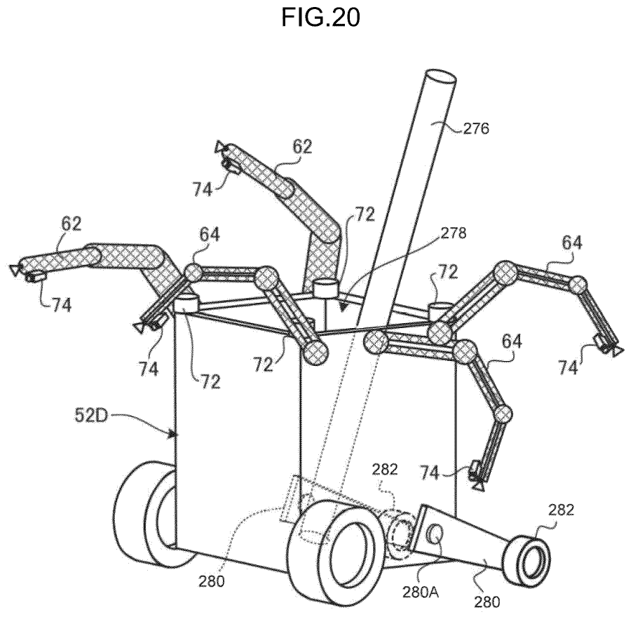

Therefore, in the embodiment, a plurality of types of cart robots 52 having structures suitable for a plurality of types of irregularly-shaped cargo and the like as shown in FIGS. 20 to 22 are prepared separately from the cart robot 52 having a standard structure.

### Long Object Transport Cart 52D

FIG. 20 is a perspective view of a long object transport cart 52D suitable for transporting a long object 276.

As shown in FIG. 20, in the long object transport cart 52D, for example, compared to the local cart 52B, a basket housing unit 278 has a vertically long structure. Therefore, the long object 276 can be housed in the basket housing unit 278 in a relatively upright state, and a force such as bending is hardly applied to the long object 276, so that damage to the cargo can be avoided.

In the long object transport cart 52D having a vertically long structure, arms 280 are attached to the basket housing unit 278 via rotation shafts 280A, respectively. Tires 282 of two of four wheels are attached to tip ends of the arms 280, respectively. This makes it easy to maintain balance during traveling.

The arm 280 rotates about the rotation shaft 280A according to acceleration/deceleration during traveling, and tilts the basket housing unit 278. Due to this tilt, the inertial force applied to the long object 276 is attenuated, and stable transport is possible.

### Spherical Object Transport Cart 52E

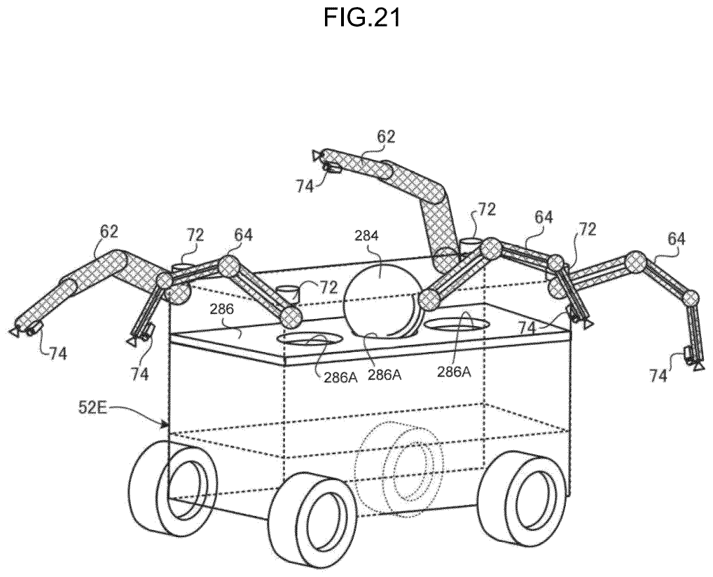

FIG. 21 is a perspective view of a spherical object transport cart 52E suitable for transporting a spherical object 284.

As shown in FIG. 21, in the spherical object transport cart 52E, for example, compared to the local cart 52B, a partition plate 286 is attached to an upper opening. The partition plate 286 is provided with a plurality of circular openings 286A. Although the openings 286A having the same radius are shown in FIG. 21, the openings may have different radii.

In a case where the spherical object 284 is picked up, it is housed in the opening 286A of the partition plate 286. Therefore, a part of the spherical object 284 is housed in the opening 286A, and is held in a stable state without rolling.

### Mass Transport Cart 52F

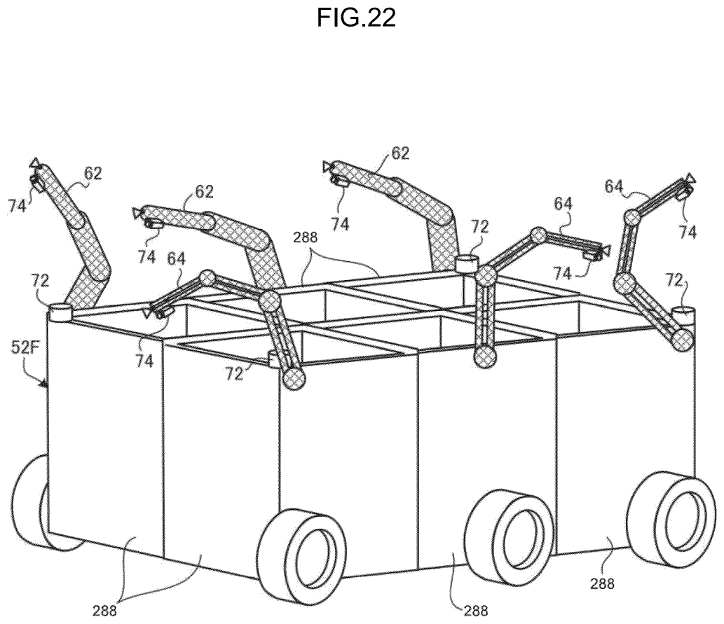

FIG. 22 is a perspective view of a mass transport cart 52F suitable for transporting a large number of baskets 56.

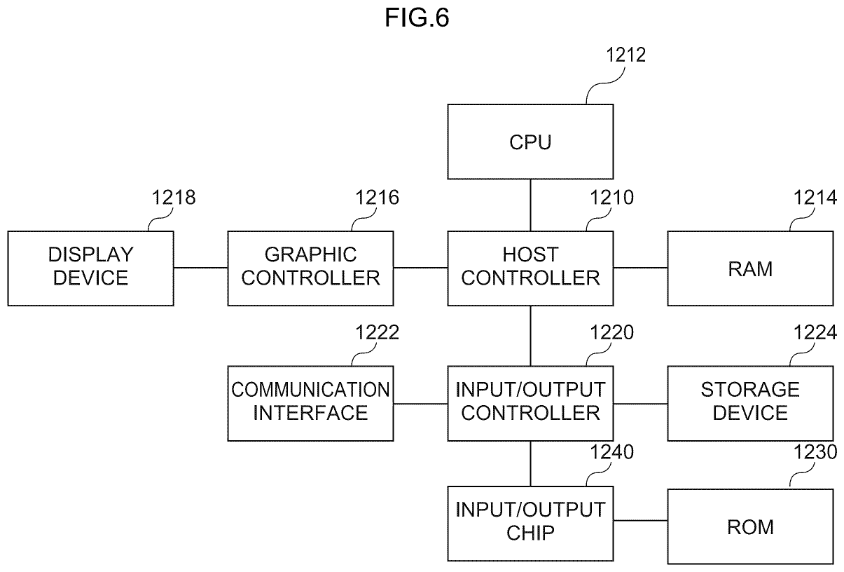

As shown in FIG. 22, the mass transport cart 52F includes a plurality of (in FIGS. 22, 6) housing units 288 compared to the local cart 52B, for example. Although the example has been shown in which the volume of each of the housing units 288 shown in FIG. 22 is smaller than that of the housing unit of the local cart 52B shown in FIG. 2, the housing unit 288 may have the same volume as the housing unit of the local cart 52B. In addition, the positions and the number of the picking arms 62 and the passing arms 64 to be attached may be determined according to the volume of the housing unit 288.

By providing the plurality of housing units 288, it is possible to transport a large number of baskets 56 (for example, a number of baskets 56 that cannot be housed in one local cart 52B) at a time, leading to an increase in efficiency, a reduction in the number of traveling cart robots, and a reduction in mutual interference (for example, contact, collision, or the like).

### Reinforcement of Monitoring “Reduction of Blind Spots”

Here, the cart robots 52 (for example, the fast cart 52A, the local cart 52B, and the direct cart 52C) of the embodiment include a plurality of arms, respectively, as described above.

In addition, any of the arms 62, 64, or 66 is attached as necessary to other cart robots 52 (for example, the direct cart 52C, the long object transport cart 52D, the spherical object transport cart 52E, and the mass transport cart 52F).

In addition, regarding the direct cart 52C, either the fast cart 52A or the local cart 52B can be applied as the direct cart 52C. A direct cart 52C including picking arms 62 may be used as a dedicated structure.

Furthermore, a plurality of types of cart robots 52 (for example, the long object transport cart 52D, the spherical object transport cart 52E, and/or the mass transport cart 52F) having structures suitable for irregularly-shaped cargo or the like may be used as dedicated to the direct lane 61.

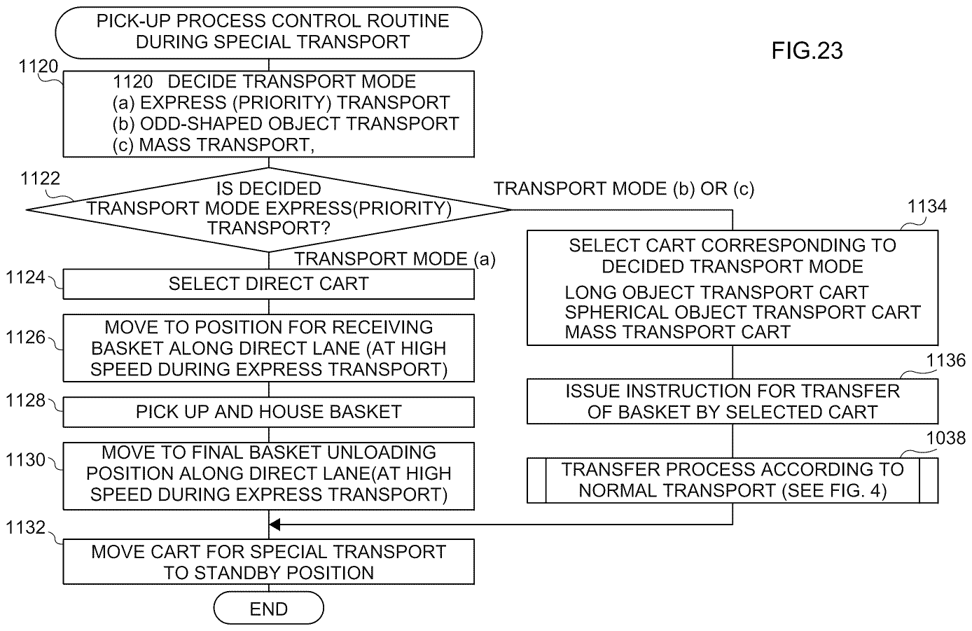

Hereinafter, actions of the embodiment will be described with reference to the flowchart of FIG. 23.

### Flow of Normal Transport Process

During normal transport, as described above, a normal transport process is executed according to the flowchart showing the pick-up process control routine for the basket 56 by the local cart 52B during normal transport shown in FIG. 4.

### Flow of Special Transport Process

FIG. 23 is a flowchart showing a pick-up process control routine for transport of an irregularly-shaped object and transport work for a large number of baskets by the long object transport cart 52D, the spherical object transport cart 52E, and the mass transport cart 52F during special transport.

In step 1120, the transport mode is decided. In step 1120, the transport mode is decided as any of (a) express (priority) transport, (b) irregularly-shaped object transport, or (c) mass transport, but transport modes other than (a) to (c) described above are not excluded. For example, a dedicated cart robot may be prepared for a transport mode for cargo having an ultra-precise structure with restricted vibrations, cargo generating odor, or the like as a target to be decided.

In the next step 1122, it is determined whether the decided transport mode (here, (a) to (c)) is (a) express (priority) transport.

In a case where an affirmative determination is made in step 1122, it is determined that the transport mode is the express (priority) transport, and the process proceeds to step 1124. In addition, in a case where a negative determination is made in step 1122, it is determined that the transport mode is the irregularly-shaped object transport or the mass transport, and the process proceeds to step 1134.

### Express (priority) Transport

In a case where an affirmative determination is made in step 1122 and the process proceeds to step 1124, the direct cart 52C is selected in step 1124. Then, the process proceeds to step 1126, and the direct cart 52C is moved along the direct lane 61 to the position for receiving the basket 56. Between the express and priority, in a case of the express, the direct cart 52C is moved at a high speed.

In the next step 1128, the basket 56 is picked up and housed, and the process proceeds to step 1130. The basket 56 is moved to the final unloading position (for example, docking station 68) along the direct lane 61 (high-speed movement during express transport), and the process proceeds to step 1132.

In step 1132, the cart for special transport (in a case where the process has proceeded from step 1130, the direct cart 52C) is moved to the standby position, and the routine ends.

### Irregularly-Shaped Object or Mass Transport

Meanwhile, in a case where a negative determination is made in step 1122 and the process proceeds to step 1134, the cart robot 52 corresponding to the decided transport mode is selected in step 1134.

That is, the long object transport cart 52D or the spherical object transport cart 52E is selected as the cart robot 52 for an irregularly-shaped object, the mass transport cart 52F is selected as the cart robot 52 for mass transport, and the process proceeds to step 1136.

In step 1136, transfer of the basket 56 or the like by the selected cart robot 52 is instructed, and the process proceeds to step 1138. A transfer process (transfer from the local cart 52B to the fast cart 52A) is executed according to the normal transport process shown in FIG. 4, and the process proceeds to step 1132.

In step 1132, the cart for special transport (in a case where the process has proceeded from step 1138, the long object transport cart 52D, the spherical object transport cart 52E, or the mass transport cart 52F) is moved to the standby position, and the routine ends.

According to the embodiment, the normal work of picking up an object to be transported that houses cargo by the arms of the local cart 52B moving at a relatively low speed along the local lane 60, and through transfer work for transferring to the arms of the fast cart 52A moving at a relatively high speed along the fast lane 58, transporting the basket 56 or the like from the pick-up position to the unloading position is processed. Meanwhile, in a case where the transport mode classified as the special transport is selected for transport of the normal work, special work is processed.

As described above, by selecting the transport work according to the type of the object to be transported, the transport work can be reliably executed even if the transport mode is changed according to the shape and amount of the object to be transported in the picking work of the cart robot 52.

In addition, in the embodiment, in a case where the transport mode classified as the special transport is a transport mode for an object to be transported that needs to be processed immediately or preferentially, the dedicated direct cart 52C for the special transport is moved along the dedicated direct lane 61, and the object to be transported is picked up by the arms of the direct cart 52C and directly transported from the pick-up position to the target position.

As described above, by using the normal work process and the special work process in combination according to the transport mode, it is possible to quickly handle the irregular work (for example, express or priority transport) without hindering the normal work. Therefore, the efficiency of the work by the cart robot 52 is improved.

In addition, in the embodiment, in a case where an object to be transported is an irregularly-shaped object to be transported that has a shape that is difficult to process in the normal work, or a large number of objects to be transported exceeding a unit transport amount of the local cart 52B and the fast cart 52A, the object to be transported is transported using the dedicated long object transport cart 52D or spherical object transport cart 52E for the special transport, or the mass transport cart 52F as the cart robot 52 for mass transport.

As described above, even if an object to be transported is difficult to process in the normal work, it is possible to handle the object to be transported. In this case, the transport control may be executed according to the control of the normal work process, and the overall work mode does not significantly change.

### Seventh Embodiment

Hereinafter, a seventh embodiment of the disclosure will be described. In the seventh embodiment, the same components as those in the first embodiment are denoted by the same reference numerals, and description of their configurations is omitted.

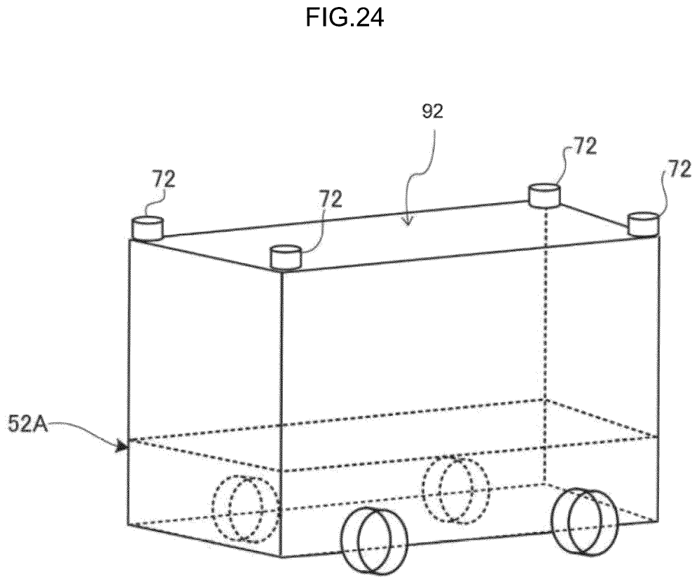

A feature of the seventh embodiment is that the fast cart 52A has no receiving arm as shown in FIG. 24.

In the first embodiment, the passing arms 64 of the local cart 52B and the receiving arms 66 of the fast cart 52A transfer the basket 56 from the local cart 52B to the fast cart 52A.

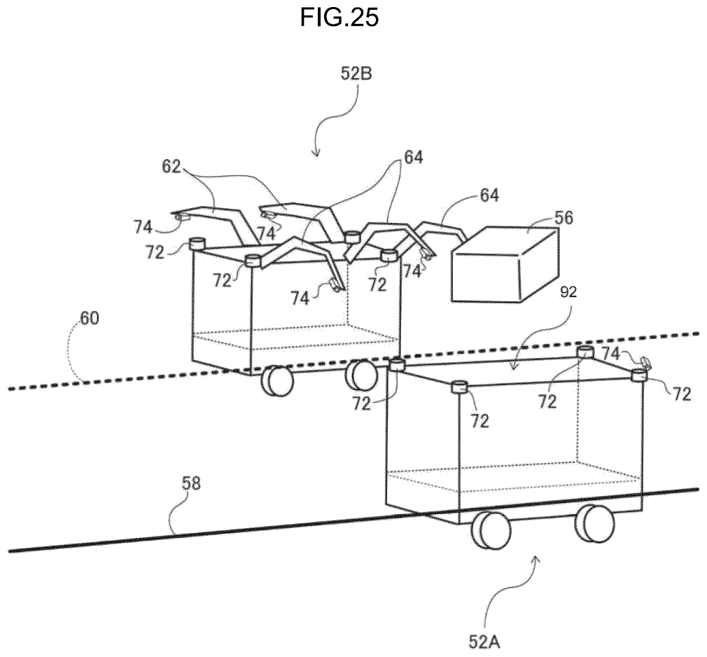

Meanwhile, in the seventh embodiment, as shown in FIG. 25, the passing arms 64 of the local cart 52B directly place the basket 56 on a basket placement unit 92 of the fast cart 52A.

In the seventh embodiment, the control unit 142 of the fast cart 52A controls the movement operation (driving of wheels) of the entire cart robot 52, and the like by using the information acquired by the information acquisition unit 140 and AI.

In addition, the control unit 142 of the fast cart 52A functions as a position control unit that controls, by using the information acquired by the information acquisition unit 140, the position of the fast cart 52A during transfer of the basket 56.

The control unit 142 of the fast cart 52A may control the position in combination with AI.

In addition, the control unit 142 of the fast cart 52A may predict the position of the local cart 52B and the movement of the passing arm 64 by using the information acquired by the information acquisition unit 140 to control the position of the fast cart 52A during transfer of the basket 56.

Hereinafter, an example of an operation during transfer of the basket 56 in the seventh embodiment will be described in detail.

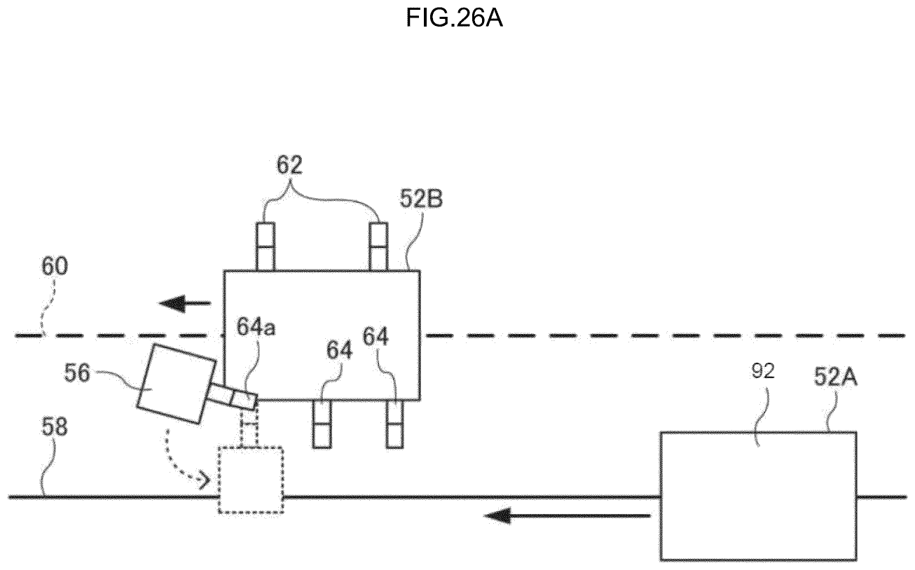

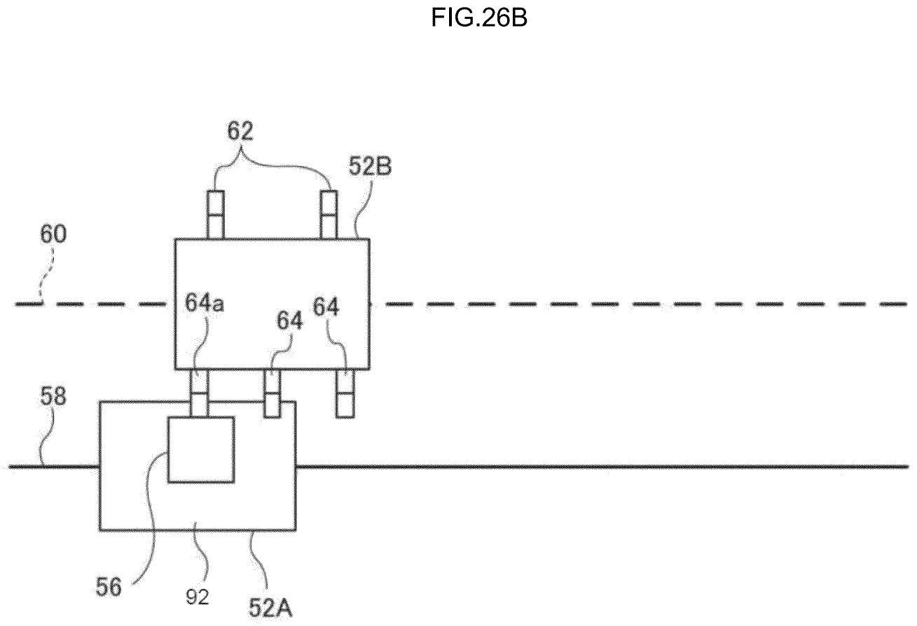

FIG. 26 shows a positional relationship between the fast cart 52A and the local cart 52B during transfer of the basket 56. FIG. 26A is a diagram showing a situation in a case where both carts approach each other, and FIG. 26B is a diagram showing a situation in a case where transfer is performed between both carts.

As shown in FIG. 26A, during transfer of the basket 56, the local cart 52B temporarily accelerates to run in parallel with the fast cart 52A, and the speed thereof is adjusted to be close to that of the fast cart 52A.

In addition, in the example shown in FIG. 26A, among the three passing arms 64, a passing arm 64A on the front side in the traveling direction holds the basket 56, and the passing arm 64A rotates counterclockwise to transfer the basket 56 to the fast cart 52A.

In a case where a command is received to receive the basket 56, the control unit 142 of the fast cart 52A acquires information such as the speed status of the local cart 52B and the movement status of the passing arm 64A holding the basket 56 from the information acquisition unit 140.

Next, the control unit 142 of the fast cart 52A predicts the position of the local cart 52B and the movement of the passing arm 64A by using the information acquired by the information acquisition unit 140 to specify at which point the fast cart 52A will approach the local cart 52B and a transfer position (for example, a relative position with respect to the local cart 52B) for the basket 56 of the passing arm 64A.

Specifically, the control unit 142 of the fast cart 52A can predict at which point the fast cart 52A will approach the local cart 52B on the basis of the change status of the relative speed between the fast cart 52A and the local cart 52B. In addition, the control unit 142 can predict a transfer position (a relative position with respect to the local cart 52B) for the basket 56 of the passing arm 64A on the basis of the movement status of the passing arm 64A holding the basket 56.

Then, the control unit 142 of the fast cart 52A controls the position of the fast cart 52A so that the passing arm 64A of the local cart 52B can place the basket 56 on the basket placement unit 92 of the fast cart 52A.

In the example shown in FIG. 26B, since the passing arm 64A on the front side in the traveling direction among the three passing arms 64 of the local cart 52B holds the basket 56, the control unit 142 of the fast cart 52A performs position control so that the fast cart 52A is positioned slightly in front of the local cart 52B at the transfer point for the basket 56. Therefore, the passing arm 64A in front of the local cart 52B in the traveling direction can place the basket 56 on the basket placement unit 92 of the fast cart 52A.

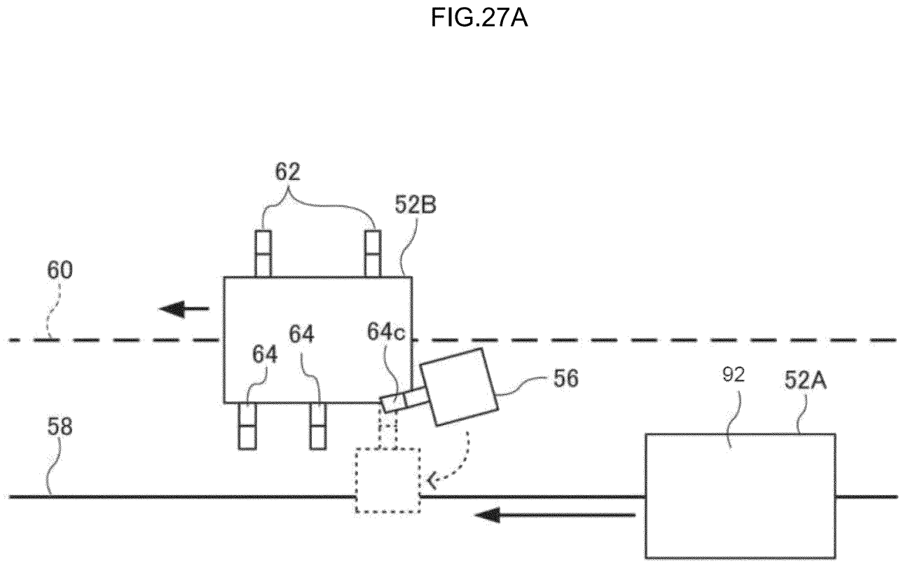

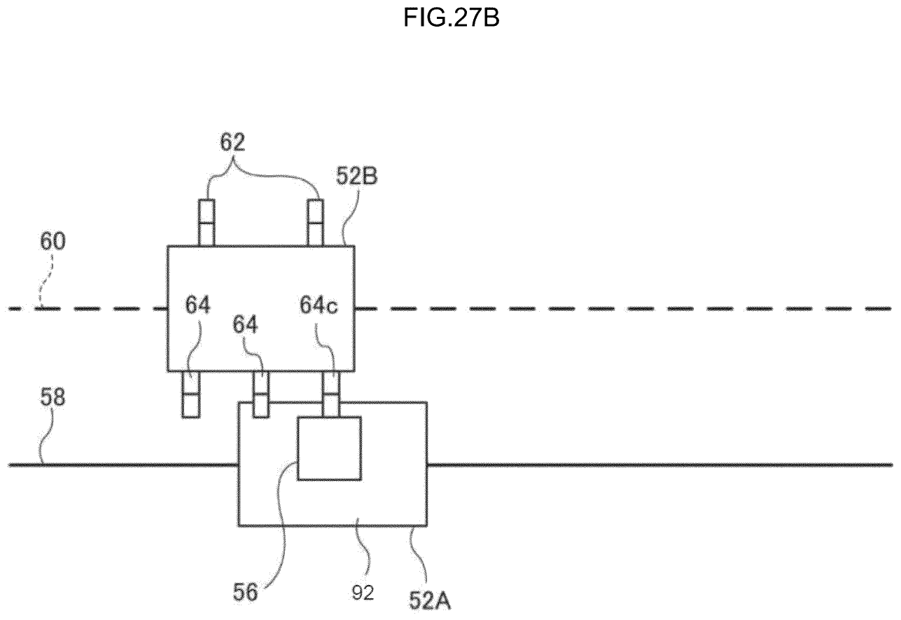

In addition, as shown in FIG. 27A, in a case where a passing arm 64C on the rear side in the traveling direction holds the basket 56 and rotates clockwise, as shown in FIG. 27B, the control unit 142 of the fast cart 52A performs position control so that the fast cart 52A is positioned slightly behind the local cart 52B at the transfer point for the basket 56.

As described above, in the control unit 142 of the fast cart 52A, by appropriately controlling the position of the fast cart 52A during transfer of the basket 56 by using the information acquired by the information acquisition unit 140, even in a case where the fast cart 52A has no receiving arm, the fast cart 52A is positioned at a position where the passing arm 64 of the local cart 52B reaches, and thus the basket 56 can be transferred to the fast cart 52A.

In addition, in the control unit 142 of the fast cart 52A, position control is performed by predicting the position of the local cart 52B and the movement of the passing arm 64A by using the information acquired by the information acquisition unit 140, even in a case where the local cart 52B is positioned at a position different from the normal position, position control can be appropriately performed.

In addition, using AI, the prediction result of the position of the local cart 52B and the movement of the passing arm 64A in the control unit 142 of the fast cart 52A and the result of the positional relationship between the local cart 52B and the fast cart 52A during transfer in a case where position control is performed on the basis of the prediction result may be accumulated for learning to improve the accuracy of the position control.

In the embodiment, the aspect has been described in which the position of the local cart 52B and the movement of the passing arm 64A are predicted by using the information acquired by the information acquisition unit 140 in the control unit 142 of the fast cart 52A. However, position control may be unambiguously performed on the basis of the information acquired by the information acquisition unit 140 without performing such prediction. In this case, for example, the speed of the fast cart 52A may be unambiguously controlled on the basis of information on the relative speed or the relative distance between the fast cart 52A and the local cart 52B.

According to the embodiment, the position of the fast cart 52A during transfer of the basket 56 is controlled on the basis of the information detected by the vehicle body sensor group 72 and the information detected by the arm sensor group 74.

Therefore, in a case where the basket 56 is transferred from the local cart 52B to the fast cart 52A, the basket 56 can be transferred even in a case where the fast cart 52A has no receiving arm.

### Eighth Embodiment

Hereinafter, an eighth embodiment of the disclosure will be described. In the embodiment, the same components as those in the first embodiment are denoted by the same reference numerals, and description of their configurations is omitted.

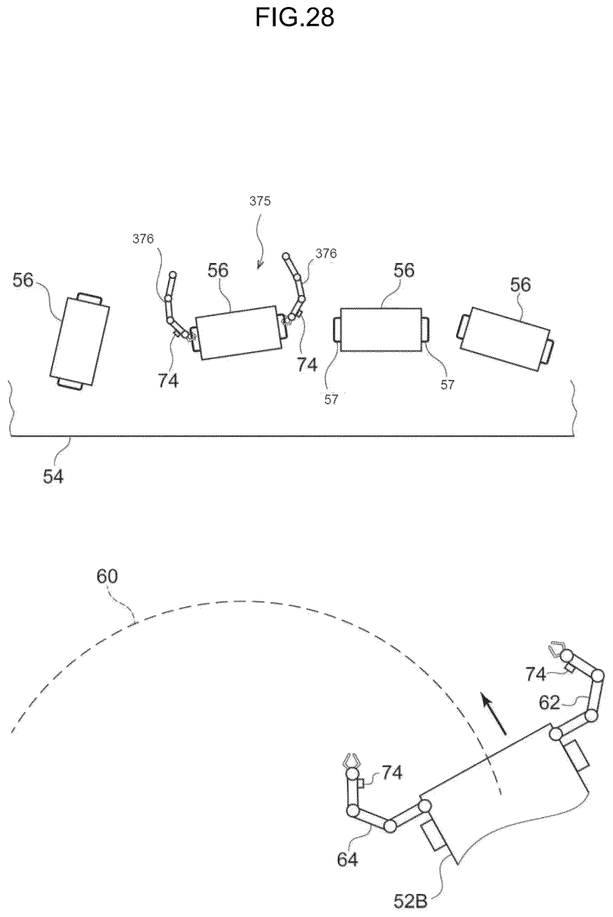

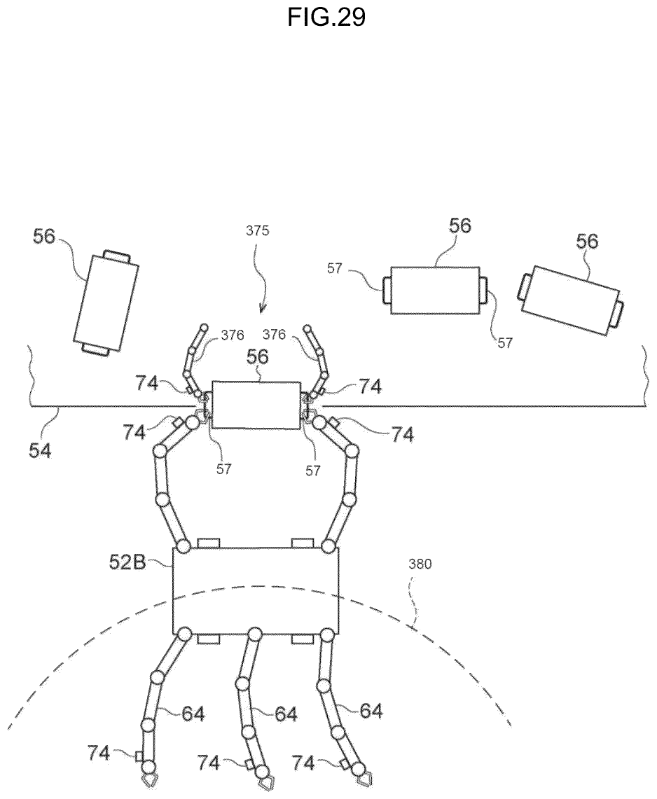

As shown in FIGS. 28 and 29, in the picking system according to the embodiment, the storage unit 54 is provided with a storage unit robot 375. The storage unit robot 375 transfers the basket 56 placed in the storage unit 54 and housing cargo to the cart robot 52 (for example, local cart 52B). Furthermore, work of transferring the basket 56 from the local cart 52B to the fast cart 52A is processed under the monitoring of the vehicle body sensor groups 72 attached to each of the storage unit robot 375, the local cart 52B, and the fast cart 52A. The storage unit robot 375 may have a structure capable of moving in the storage unit 54 or a structure fixed to the storage unit 54.

The picking system has a pick-up arm 376, a picking arm 62 and a passing arm 64 as arms, an arm sensor group 74, and a control unit 142 (see FIG. 5).

The pick-up arm 376 is an arm that is attached to the storage unit robot 375 and picks up the basket 56 of the storage unit 54. For example, two pick-up arms 376 are attached to one storage unit robot 375. The arm sensor group 74 is attached to a tip end portion of the pick-up arm 376.

The arm is a portion that is attached to the local cart 52B and executes reception of the basket 56 from the pick-up arm 376 and transfer to the fast cart 52A. As the arm, for example, the picking arm 62 and the passing arm 64 similar to those of the first embodiment are provided. The arm sensor group 74 is attached to tip end portions of the picking arm 62 and the passing arm 64.

The control unit 142 controls the pick-up arm 376 to adjust the orientation of the basket 56 during transfer of the basket 56 from the pick-up arm 376 to the picking arm 62 on the basis of the information detected by the vehicle body sensor group 72 and the information detected by the arm sensor group 74.

Furthermore, the control unit 142 may control the pick-up arm 376 so that the picking arm 62 can catch a handle 57 of the basket 56 during transfer of the basket 56.

Hereinafter, an example of an operation during transfer of the basket 56 in the eighth embodiment will be described in detail.

In the state of FIG. 28, the local cart 52B receives a command to pick up the basket 56, and advances toward a transfer position for the basket 56 in the storage unit 54. In a case where the command is received to transfer the basket 56, the control unit 142 of the storage unit robot 375 acquires information such as the position and/or the speed status of the local cart 52B from the information acquisition unit 140 (see FIG. 5). Then, the control unit 142 controls the pick-up arm 376 to grip a part (for example, handle 57) of the basket 56 that is a transfer target. In this case, even if the orientation of the basket 56 in the storage unit 54 varies due to the movement of the storage unit robot 375 in the storage unit 54, the control unit 142 of the storage unit robot 375 can appropriately pick up the target basket 56 on the basis of the information from the information acquisition unit 140.

In a case where the storage unit robot 375 has a structure fixed to the storage unit 54, for example, a structure in which a conveyor that transports the basket 56 in a circulating manner is installed in the storage unit 54, and the target basket 56 transported by the conveyor is picked up by the fixed storage unit robot 375 may be adopted. For example, the fixed storage unit robot 375 can freely rotate with the vertical direction as its rotation axis. Other than the fixed storage unit robot 375, a robot that moves the target basket 56 to a position where the storage unit robot 375 can pick up the basket 56 may be positioned. A self-propelled robot, a crane robot, or the like can be used as the robot.

In the state of FIG. 29, the local cart 52B reaches the transfer position for the basket 56, and the basket 56 is transferred. In accordance with this timing, the control unit 142 of the storage unit robot 375 controls the pick-up arm 376 to adjust the orientation of the basket 56 and to put out the basket 56 toward the picking arm 62 of the local cart 52B. In a case where the basket 56 is provided with the handle 57, the control unit 142 of the storage unit robot 375 controls the pick-up arm 376 so that the picking arm 62 easily catches the handle 57. The picking arm 62 receives the basket 56 from the pick-up arm 376. The subsequent work is the same as that in the first embodiment.

The control unit 142 of the storage unit robot 375 may put out the basket 56 in accordance with the interval between the local carts 52B moving on the local lane 60 on the basis of the information from the information acquisition unit 140.

As described above, according to the embodiment, the basket 56 is smoothly transferred from the storage unit robot 375 to the local cart 52B. In addition, after the basket 56 is transferred to the local cart 52B, another basket 56 can be picked up and transferred to the local cart 52B. In this manner, the baskets 56 can be transferred from the storage unit 54 to the local cart 52B one after another.

### Implementation Modes of Information Processing Device 14 of Cart Robot 52

FIG. 6 schematically shows an example of a hardware configuration of a computer 1200 that functions as the information processing device 14. A program installed in the computer 1200 can cause the computer 1200 to function as one or more “units” of the device according to each embodiment described above, or cause the computer 1200 to execute an operation associated with the device according to each embodiment described above or one or more “units” thereof, and/or cause the computer 1200 to execute a process according to each embodiment described above or stages of the process. Such a program may be executed by a CPU 1212 to cause the computer 1200 to execute a specific operation associated with some or all of the blocks in the flowcharts and block diagrams described herein.

The computer 1200 according to each embodiment described above includes the CPU 1212, a RAM 1214, and a graphic controller 1216, which are connected to each other by a host controller 1210. The computer 1200 also includes input/output units such as a communication interface 1222, a storage device 1224, a DVD drive, and an IC card drive, which are connected to the host controller 1210 via an input/output controller 1220. The DVD drive may be a DVD-ROM drive, a DVD-RAM drive, or the like. The storage device 1224 may be a hard disk drive, a solid state drive, or the like. The computer 1200 also includes input/output units such as a ROM 1230 and a keyboard, which are connected to the input/output controller 1220 via an input/output chip 1240.

The CPU 1212 is operated according to programs stored in the ROM 1230 and the RAM 1214, thereby controlling the units. The graphic controller 1216 acquires image data generated by the CPU 1212 in a frame buffer or the like provided in the RAM 1214 or itself, and causes the image data to be displayed on a display device 1218.

The communication interface 1222 communicates with other electronic devices via a network. The storage device 1224 stores programs and data used by the CPU 1212 in the computer 1200. The DVD drive reads programs or data from a DVD-ROM or the like and provides the programs or data to the storage device 1224. The IC card drive reads programs and data from and/or writes programs and data to an IC card.

The ROM 1230 stores therein a boot program or the like executed by the computer 1200 at activation, and/or a program dependent on hardware of the computer 1200. The input/output chip 1240 may also connect various input/output units to the input/output controller 1220 via a USB port, a parallel port, a serial port, a keyboard port, a mouse port, or the like.

Programs are provided by a computer-readable storage medium such as a DVD-ROM or an IC card. The programs are read from a computer-readable storage medium, installed in the storage device 1224, the RAM 1214, or the ROM 1230, which is also an example of a computer-readable storage medium, and executed by the CPU 1212. Information processes described in these programs are read by the computer 1200 to provide cooperation between the programs and the various types of hardware resources. Devices or methods may be configured by realizing the operation or process of information according to use of the computer 1200.

For example, in a case where communication is executed between the computer 1200 and an external device, the CPU 1212 may execute a communication program loaded into the RAM 1214 and instruct the communication interface 1222 to perform a communication processing on the basis of the process described in the communication program. Under the control of the CPU 1212, the communication interface 1222 reads transmission data stored in a transmission buffer region provided in a recording medium such as the RAM 1214, the storage device 1224, a DVD-ROM, or an IC card and transmits the read transmission data to the network, or writes reception data received from the network to a reception buffer region or the like provided on the recording medium.

In addition, the CPU 1212 may cause the RAM 1214 to read all or a necessary portion of files or database stored in an external recording medium such as the storage device 1224, a DVD drive (DVD-ROM), or an IC card, and may execute various types of processes on the data on the RAM 1214. Next, the CPU 1212 may write back the processed data to the external recording medium.

Various types of information such as various types of programs, data, tables, and databases may be stored in a recording medium and subjected to an information process. The CPU 1212 may execute, on the data read from the RAM 1214, various types of processes including various types of operations, information processes, condition determinations, conditional branching, unconditional branching, information search/replacement, and the like, which are described throughout the disclosure and specified by a program's instruction sequence, and writes back the result to the RAM 1214. In addition, the CPU 1212 may search for information in the files, database, or the like in the recording medium. For example, in a case where a plurality of entries each having an attribute value of a first attribute associated with an attribute value of a second attribute are stored in a recording medium, the CPU 1212 may search for an entry in which the attribute value of the first attribute matches a designated condition from the plurality of entries, read the attribute value of the second attribute stored in the entry, and thereby acquire the attribute value of the second attribute associated with the first attribute satisfying the predetermined condition.

The programs or software modules described above may be stored in a computer-readable storage medium on the computer 1200 or in the vicinity of the computer 1200. In addition, a recording medium such as a hard disk or a RAM provided in a server system connected to a dedicated communication network or the Internet can be used as a computer-readable storage medium, and thus provides programs to the computer 1200 via the network.

The blocks in the flowcharts and block diagrams in each embodiment described above may represent stages of a process in which an operation is executed or “units” of a device that is responsible for executing the operation. Specific stages and “units” may be implemented by a dedicated circuit, a programmable circuit supplied together with a computer-readable instruction stored on a computer-readable storage medium, and/or a processor supplied together with a computer-readable instruction stored on a computer-readable storage medium. The dedicated circuit may include digital and/or analog hardware circuits, and may include integrated circuits (ICs) and/or discrete circuits. The programmable circuit may include, for example, a reconfigurable hardware circuit including: logical AND, logical OR, exclusive OR, negative AND, negative OR, and other logical operations; a flip-flop; a register, and a memory element, such as a field programmable gate array (FPGA) or a programmable logic array (PLA).

The computer-readable storage medium may include any tangible device capable of storing an instruction executed by an appropriate device. As a result, the computer-readable storage medium having an instruction stored thereon includes a product including an instruction that can be executed in order to create means for executing the operation specified in the flowcharts or block diagrams. Examples of the computer-readable storage medium may include an electronic storage medium, a magnetic storage medium, an optical storage medium, an electromagnetic storage medium, and a semiconductor storage medium. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, and an integrated circuit card.

The computer-readable instruction may include an assembler instruction, an instruction-set-architecture (ISA) instruction, a machine instruction, a machine dependent instruction, a microcode, a firmware instruction, state setting data, or either a source code or an object code described in any combination of one or more programming languages, including an object oriented programming language such as Smalltalk (registered trademark), JAVA (registered trademark), or C++, and a conventional procedural programming language such as a “C” programming language or a similar programming language.

The computer-readable instruction may be provided to a general-purpose computer, a special-purpose computer, or a processor or programmable circuit of another programmable data processing device, locally or via a local area network (LAN) or a wide area network (WAN) such as the Internet so that the general-purpose computer, the special-purpose computer, or the processor or programmable circuit of another programmable data processing device executes the computer-readable instruction in order to generate means for executing the operation specified in the flowcharts or block diagrams. Examples of the processor include a computer processor, a processing unit, a microprocessor, a digital signal processor, a controller, and a microcontroller.

Although the disclosure has been described with reference to the embodiments, the technical scope of the disclosure is not limited to the scope described in the embodiments. It is apparent to those skilled in the art that various changes or improvements can be added to the above-described embodiments. It is apparent from the description of the claims that modes with such changes or improvements added thereto can also be included in the technical scope of the disclosure.

It should be noted that processes such as operations, procedures, steps, and stages in the devices, systems, programs, and methods shown in the claims, specification, and drawings can be executed in any order as long as the order is not specifically indicated by “before”, “prior to”, or the like and as long as the output from a previous process is not used in a later process. Even if the operation flow is described using “first”, “next”, or the like for the sake of convenience in the claims, specification, and drawings, it does not necessarily mean that the process must be performed in this order.

Herein, “A and/or B” is synonymous with “at least one of A or B.” That is, “A and/or B” means only A, only B, or a combination of A and B. In addition, herein, the same concept as “A and/or B” is applied also in a case where three or more matters are linked and expressed by “and/or.”

All documents, patent applications, and technical standards described herein are incorporated herein by reference to the same extent as if each individual document, patent application, and technical standard were specifically and individually indicated to be incorporated by reference.

The disclosures of Japanese Patent Application No. 2022-168243 filed on Oct. 20, 2022, Japanese Patent Application No. 2022-180272 filed on Nov. 10, 2022, Japanese Patent Application No. 2022-183406 filed on Nov. 16, 2022, Japanese Patent Application No. 2022-186437 filed on Nov. 22, 2022, Japanese Patent Application No. 2022-193779 filed on Dec. 2, 2022, Japanese Patent Application No. 2022-194433 filed on Dec. 5, 2022, and Japanese Patent Application No. 2023-12295 filed on Jan. 30, 2023 are incorporated herein by reference in their entirety.

1. A picking system processing work of picking up a basket that houses cargo by a first cart robot moving at a relatively low speed along a local lane, and transferring the basket to a second cart robot moving at a relatively high speed along a fast lane, under monitoring of a vehicle body sensor group attached to a vehicle body of each of the first cart robot and the second cart robot, the picking system comprising:
a pick-up arm that is attached to the first cart robot to pick up the basket;
a passing arm that is attached to the first cart robot to transfer the basket to the second cart robot;
a receiving arm that is attached to the second cart robot to receive the basket from the passing arm;
an arm sensor group that is attached to a tip end portion of at least one of the pick-up arm, the passing arm, or the receiving arm; and
an interpolation control unit that interpolates a blind spot of the vehicle body sensor group associated with movement of the pick-up arm, the passing arm, and the receiving arm on a basis of information detected by the arm sensor group.

2. The picking system according to claim 1,
wherein the arm sensor group is attached to a tip end portion of any one of the pick-up arm, the passing arm, or the receiving arm, the respective arms having a multi-axis arm structure.

3. The picking system according to claim 1,
wherein the arm sensor group is attached an inner side of a wrist-specification joint of any one of the pick-up arm, the passing arm, or the receiving arm, the respective arms having a multi-axis arm structure.

4. The picking system according to claim 1,
wherein a step structure unit is provided between the local lane and the fast lane, the basket discharged from the first cart robot is transferred to the second cart robot via a transfer path of the step structure unit, movement of the basket is possible using a gravity generated by at least a height difference.

5. The picking system according to claim 4,
wherein the local lane is disposed relatively at high position, the fast lane is disposed relatively at low position, and the transfer path is an inclination unit connecting the local lane and the fast lane, and
the basket discharged from the first cart robot slides down the inclination unit and moved to a catching position of the second cart robot.

6. The picking system according to claim 1,
wherein a snake arm camera that is attached to the vehicle body and that includes an arm unit capable of adjusting a connection angle of each of a plurality of link units connected via joint units to the arm unit by an adjustment mechanism unit, and an image-capturing unit attached to a tip end portion of the arm unit, and
a blind spot determination unit that determines whether there is a blind spot region of the vehicle body sensor group generated during the series of work by the cart robot are provided, and
the adjustment mechanism unit is controlled on a basis of a determination result in the blind spot determination unit to adjust a connection angle between the link units, and the blind spot region is interpolated by capturing an image thereof with the image-capturing unit.

7. The picking system according to claim 6,
wherein a pick-up arm that picks up the basket and a passing arm that sends the basket to the second cart robot are attached to the first cart robot, and a receiving arm that receives the basket from the passing arm is attached to the second cart robot, and
the snake arm camera is attached to at least one of the first cart robot or the second cart robot separately from a working arm group constituting the pick-up arm, the passing arm, and the receiving arm.

8. The picking system according to claim 6,
wherein a pick-up arm that picks up the basket and a passing arm that sends the basket to the second cart robot are attached to the first cart robot, and a receiving arm that receives the basket from the passing arm is attached to the second cart robot, and
a working arm group constituting the pick-up arm, the passing arm, and the receiving arm each functions as the snake arm camera.

9. The picking system according to claim 8,
wherein the image-capturing unit of the snake arm camera is attached at an inner side of a wrist-specification joint of the working arm group.

10. The picking system according to claim 1,
wherein, in a case in which the picking and the transferring work is set as the series of normal work, a charging work control unit is provided to control charging work for charging a battery serving as a power source of the first cart robot or the second cart robot, the charging work is executed as separate work from the series of normal work, and
monitoring by the vehicle body sensor group and the arm sensor group is continued during the charging work.

11. The picking system according to claim 10,
wherein the charging work comprises:
during traveling along the local lane, taking in a charging pack capable of charging the power source in place of the basket by the first cart robot,
charging a battery of the first cart robot, or charging a battery of the second cart robot by transferring the charging pack to the second cart robot, and
returning after charging, and
the series of normal work is executed in parallel to the charging work.

12. The picking system according to claim 10,
wherein the charging work comprises;
drawing the first cart robot and the second cart robot that need to be charged to a charging station via charging lanes respectively connected to points with respect to the local lane and the fast lane, and
sending the first cart robot and the second cart robot to the local lane and the fast lane via the charging lanes after charging at the charging station, and
the series of normal work is executed in parallel to the charging work.

13. A picking system that transports an object to be transported that houses cargo by using a cart robot, the picking system comprising:
a normal work process control unit that processes normal work of picking up the object to be transported by an arm of a first cart robot moving at a relatively low speed along a local lane, and through transfer work for transferring to an arm of the second cart robot moving at a relatively high speed along a fast lane, transporting the object to be transported from a pick-up position to an unloading position; and
a special work process control unit that processes special work in a case in which a transport mode classified as special transport is selected for transport of the normal work.

14. (canceled)

15 . (canceled)

16 . (canceled)

17 . A picking system that processes work of picking up a basket that houses cargo by a first cart robot moving at a relatively low speed along a local lane and transferring the basket to a second cart robot moving at a relatively high speed along a fast lane under monitoring of a vehicle body sensor group attached to a vehicle body of each of the first cart robot and the second cart robot, the picking system comprising:
an arm unit that is attached to the first cart robot to execute pick-up of the basket and transfer of the basket;
an arm sensor group that is attached to a tip end portion of the arm unit; and
a position control unit that controls a position of the second cart robot during transfer of the basket on a basis of information detected by the vehicle body sensor group and information detected by the arm sensor group.

18. The picking system according to claim 17,
wherein the position control unit predicts a position of the first cart robot and movement of the arm unit on a basis of information detected by the arm sensor group to control the position of the second cart robot during transfer of the basket.

19. (canceled)

20. (canceled)

21. (canceled)
